(19) United States
(12) Patent Application Publication
(10) Pub. No.: US 2006/0007086 A1
(43) Pub. Date: Jan. 12, 2006

(54) Liquid crystal display device, signal transmission film, and display apparatus having the signal transmission film

(76) Inventors: Young-Joon Rhee, Seoul (KR); Kwang-Soo Lee, Yongin-si (KR); Yang-Suk Ahn, Yongin-si (KR); Gwan-Sik Yoon, Suwon-si (KR); Hee-Jae Park, Nam-gu (KR); Jin-Ho Park, Suwon-si (KR); Hee-Bum Park, Seongnam-si (KR); Ock-Jin Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/176,543

(22) Filed: Jul. 7, 2005

(30) Foreign Application Priority Data
Jul. 9, 2004 (KR) 2004-53399
Aug. 20, 2004 (KR) 2004-65895

(51) Int. Cl. G09G 3/36

(52) U.S. Cl. 345/87

(57) ABSTRACT

A signal transmission film includes a conductive pattern having a resin-extruding path making contact with an anisotropic conductive film including a resin so that the resin is extruded through the resin-extruding path for providing a stable connection. Alternatively, the resin-extruding path is provided in a signal providing pattern on a display panel. Also, a flexible printed circuit includes a gate driving terminal having at least two sub terminals electrically connected to each other. Each of the sub terminals is electrically connected to a gate driving control signal pad of a liquid crystal display panel for enhancing contact stability.

This application claims priority to Korean Patent Application No. 2004-53399 filed on Jul. 9, 2004 and Korean Patent Application No. 2004-65895 filed on Aug. 20, 2004 and all the benefits accruing therefrom under 35 U.S.C. §119, and the contents of which in their entirety are herein incorporated by reference.

### BACKGROUND OF THE INVENTION

1. Field of the Invention

The present invention relates to a display device, a signal transmission film, and a display apparatus having the signal transmission film. More particularly, the present invention relates to a liquid crystal display device displaying images through a liquid crystal display panel, a signal transmission film that transfers driving signals to a display apparatus, and a display apparatus having the signal transmission film.

2. Description of the Related Art

Generally, a display apparatus, for example, a cathode ray tube (“CRT”) display apparatus, a liquid crystal display (“LCD”) apparatus, and an organic electro luminescence display (“EL”) apparatus convert a data processed by an information-processing device into an image.

Generally, electronic devices such as a mobile phone, a digital camera, a notebook computer, a monitor, etc. employ various kinds of display devices. The above-mentioned electronic devices may employ a liquid crystal display (“LCD”) device.

The LCD device displays images by using liquid crystal. The LCD device has many merits such as thin thickness, a lightweight structure, low driving voltage, low power consumption, etc. Therefore, the LCD device is used in various fields.

The LCD apparatus includes a liquid crystal controlling part and a light providing part. The liquid crystal controlling part controls an arrangement of liquid crystal molecules of the liquid crystal layer. The light providing part provides the liquid crystal controlling part with light. The light generated from the light providing part passes through the liquid crystal layer of the liquid crystal controlling part.

The liquid crystal controlling part includes a display panel, a printed circuit board (“PCB”), at least one tape carrier package (“TCP”), etc. The TCP electrically connects signal lines of the display panel to signal lines of the PCB. An anisotropic conductive film having a resin and a micro-conductive ball in the resin is interposed between the TCP and the PCB or the display panel and the TCP.

A conventional TCP has been disclosed in Korean Laid-Open Patent Publication No. 2000-0066493 (Korean Patent Application No. 1996-13650), which is entitled “Tape Carrier Package, Liquid Crystal Display panel assembly including the Tape Carrier Package, Liquid Crystal Display device including the Liquid Crystal panel assembly and method for assembling the same. According to the above conventional TCP, a unified PCB generates a gate driving signal and a data driving signal for displaying an image, and the gate driving signal is applied to one of gate lines formed on the display panel.

However, a signal transferring pattern of the TCP, which transfers a power source, distorts an image due to the electric resistance thereof and is easily separated from the display panel, and is easily corroded.

The LCD device includes an LCD panel displaying images, a driver circuit board generating a data driving control signal and a gate driving control signal to drive the LCD panel, and a data flexible printed circuit (“FPC”) and a gate FPC connecting the driver circuit board to the LCD panel. The LCD panel includes a plurality of gate lines extended along a first direction, and a plurality of data lines extended along a second direction substantially perpendicular to the first direction. The LCD panel also includes a gate driving control signal line that transmits the gate driving control signal from the data FPC to the gate FPC. The gate driving control signal line is wider than a width of the gate lines in order to reduce electrical resistance.

The gate FPC includes gate signal terminals that are electrically connected to the gate lines, respectively, and gate driving terminals that are electrically connected to the gate driving control signal line. A width of the gate driving control signal line is greater than a width of the gate lines, so that a width of the gate driving terminals is greater than a width of the gate signal terminals. One of the gate driving terminals, to which a gate-on signal Von is applied, has a width that is five times greater than a width of the gate signal terminals, and one of the gate driving terminals, to which a gate-off signal Voff is applied, has a width that is twenty times greater than a width of the gate signal terminals.

The gate FPC is connected to the LCD panel through an anisotropic conductive film (“ACF”). When the ACF is heated and compressed to electrically connect the gate FPC to the LCD panel, an electrical connection between the gate signal terminals and the gate lines are better than an electrical connection between the gate driving terminals and the gate driving control signal line, even though a width of the driving terminals is wider than a width of the gate signal terminals. When the electrical connection is deteriorated, an electrically contacting portion may be damaged.

### BRIEF SUMMARY OF THE INVENTION

Accordingly, the present invention is provided to substantially obviate one or more problems due to limitations and disadvantages of the related art.

In one embodiment, the present invention provides a liquid crystal display device.

In exemplary embodiments of a liquid crystal display device, the liquid crystal display device includes a liquid crystal display panel, a flexible circuit film and an anisotropic conductive film. The liquid crystal display panel has a plurality of gate lines extended along a first direction, a plurality of gate pads that are electrically connected to the gate lines, respectively, a gate driving control signal line that transfers a gate driving control signal, and a gate driving control signal pad that is electrically connected to the gate driving control signal line. The flexible circuit film includes a gate driving chip that applies a gate driving signal to the gate lines based on the gate driving control signal, a plurality of gate signal terminals that are electrically connected to the gate pads, respectively, and a gate driving terminal having at least two sub terminals electrically connected to each other. Each of the sub terminals is electrically connected to the gate driving control signal pad. The anisotropic conductive film is disposed between the liquid crystal display panel and the flexible circuit film to electrically connect the flexible circuit film to the liquid crystal display panel.

In other exemplary embodiments of a liquid crystal display device, the liquid crystal display device includes a liquid crystal display panel, a flexible circuit film, an anisotropic conductive film and a backlight assembly. The liquid crystal display panel has a plurality of gate lines extended along a first direction, a plurality of gate pads that are electrically connected to the gate lines, respectively, a gate driving control signal line that transfers a gate driving control signal, and a gate driving control signal pad that is electrically connected to the gate driving control signal line. The flexible circuit film includes a gate driving chip that applies a gate driving signal to the gate lines based on the gate driving control signal, a plurality of gate signal terminals that are electrically connected to the gate pads, respectively, and a gate driving terminal having at least two sub terminals electrically connected to each other. Each of the sub terminals is electrically connected to the gate driving control signal pad. The anisotropic conductive film is disposed between the liquid crystal display panel and the flexible circuit film to electrically connect the flexible circuit film to the liquid crystal display panel. The backlight assembly is disposed under the liquid crystal display panel to provide the liquid crystal display panel with light.

In an exemplary embodiment of a flexible circuit film for use on a thin film transistor substrate of a liquid crystal display panel, the flexible circuit film includes a gate signal terminal and a gate driving terminal, the gate driving terminal having a first terminal, the first terminal having a plurality of sub terminals electrically connected to each other and spaced apart from each other within the first terminal, wherein the first terminal has a first terminal width that is larger than a width of the gate signal terminal.

Therefore, the gate driving terminal having a wider width than that of the gate signal terminal is divided into a plurality of sub terminals to enhance stability of contact between the liquid crystal display panel and the flexible circuit film.

Additionally, when the gate driving terminal is divided into a plurality of sub terminals having different widths, the stability contact is enhanced and contact resistance is reduced.

The present invention further provides a signal transmission film capable of improving an image display quality.

The present invention also provides a display apparatus including the above-mentioned the signal transmission film.

In one exemplary embodiment of a signal transmission film, the signal transmission film includes a body and a conductive pattern. The conductive pattern is formed on the body. A portion of the conductive pattern has a resin-extruding path. The portion makes contact with an anisotropic conductive film including a resin and a micro-conductive ball when the signal transmission film is combined with the anisotropic conductive film, so that the resin is extruded through the resin-extruding path.

In another exemplary embodiment, a signal transmission film includes a base substrate, a driver integrated circuit (“IC”), a plurality of first conductive patterns and a plurality of second conductive patterns. The base substrate includes a first peripheral portion and a second peripheral portion opposite the first peripheral portion. The driver IC is disposed on the base substrate. The driver IC includes a plurality of first terminals and a plurality of second terminals. The first conductive patterns are extended in parallel with each other from the first peripheral portion to the first terminals and electrically connected to the first terminals, respectively. The second conductive patterns are extended in parallel with each other from the first peripheral portion to the second terminals and electrically connected to the second terminals, respectively. The second conductive patterns have a first resin-extruding path formed at the first peripheral portion.

In another exemplary embodiment, a signal transmission film includes a base substrate, a driver IC, a plurality of first conductive patterns and a plurality of second conductive patterns. The base substrate includes a first peripheral portion and a second peripheral portion opposite the first peripheral portion. The driver IC is formed on the base substrate. The driver IC includes a plurality of first terminals and a plurality of second terminals. The first conductive patterns are extended in parallel with each other from the first peripheral portion to the first terminals and electrically connected to the first terminals, respectively. The second conductive patterns are extended in parallel with each other from the second peripheral portion to the second terminals and electrically connected to the second terminals, respectively. The second conductive patterns have a resin-extruding path formed at the second peripheral portion.

In another exemplary embodiment, a liquid crystal display apparatus includes a unified printed circuit board, a display panel, a signal transmission film, and an anisotropic conductive film. The unified printed circuit board generates a first driving signal and a second driving signal. The display panel includes a first signal line having a first width and a second signal line having a second width larger than the first width. The signal transmission film includes a base film, a first driving signal line, and a second driving signal line. The first driving signal line transfers the first driving signal to the first signal line. The second driving signal line transfers the second driving signal to the second signal line. The second driving signal line includes a resin-extruding path. The anisotropic conductive film is interposed between the signal transmission film and the display panel. The anisotropic conductive film includes a reflowable resin and a micro-conductive ball. The resin is extruded through the resin-extruding path when the anisotropic conductive film is combined with the signal transmission film.

In another exemplary embodiment, a display apparatus includes a display panel having a signal providing pattern, a signal transmission film including a conductive pattern, a resin extruding path formed in at least one of the signal providing pattern and the conductive pattern, and an anisotropic conductive film interposed between an end portion of the signal providing pattern and an end portion of the conductive pattern, the anisotropic conductive film including a resin extruded through the resin-extruding path.

Therefore, the anisotropic conductive film is stably connected to the signal transmission film.

### BRIEF DESCRIPTION OF THE DRAWINGS

The above and other features and advantages of the present invention will become more apparent by describing in detailed exemplary embodiments thereof with reference to the accompanying drawings wherein:

FIG. 1 is a perspective view illustrating an exemplary embodiment of a liquid crystal display (“LCD”) device according to the present invention;

FIG. 2 is a plan view illustrating the LCD device in FIG. 1;

FIG. 3 is an enlarged view illustrating portion ‘A’ in FIG. 2;

FIG. 4 is a cross-sectional view taken along line I-I′ in FIG. 1;

FIG. 5 is a plan view illustrating a first flexible printed circuit in FIG. 1;

FIG. 6 is an enlarged view illustrating portion ‘B’ in FIG. 5;

FIG. 7 is a cross-sectional view illustrating another exemplary embodiment of an LCD device according to the present invention;

FIG. 8 is an enlarged view illustrating a portion of a first flexible printed circuit in FIG. 7;

FIG. 9 is an exploded perspective view illustrating still another exemplary embodiment of an LCD device according to the present invention;

FIG. 10 is a perspective view illustrating an exemplary embodiment of a signal transmission film;

FIG. 11 is an enlarged view illustrating portion ‘C’ in FIG. 10;

FIG. 12 is an enlarged view illustrating portion ‘D’ in FIG. 10;

FIG. 13 is a perspective view illustrating another exemplary embodiment of a first resin-extruding path;

FIG. 14 is a perspective view illustrating another exemplary embodiment of a signal transmission film;

FIG. 15 is an enlarged view illustrating portion ‘E’ in FIG. 14;

FIG. 16 is a perspective view illustrating another exemplary embodiment of a resin-extruding path;

FIG. 17 is an exploded perspective view illustrating an exemplary embodiment of a display apparatus;

FIG. 18 is a circuit diagram illustrating a pixel formed on the thin film transistor substrate;

FIG. 19 is an enlarged view illustrating portion ‘F’ in FIG. 17;

FIG. 20 is a cross sectional view illustrating an exemplary embodiment of a thin film transistor substrate combined with a gate tape carrier package;

FIG. 21 is a cross sectional view illustrating another exemplary embodiment of a thin film transistor combined with a gate tape carrier package; and

FIG. 22 is a cross sectional view illustrating still another exemplary embodiment of a thin film transistor substrate combined with a gate tape carrier package.

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular embodiments. Rather, these embodiments are provided so that this disclosure will be thorough and complete, and will fully convey the concept of the invention to those skilled in the art by way of example and not of limitation.

Hereinafter the embodiments of the present invention will be described in detail with reference to the accompanied drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

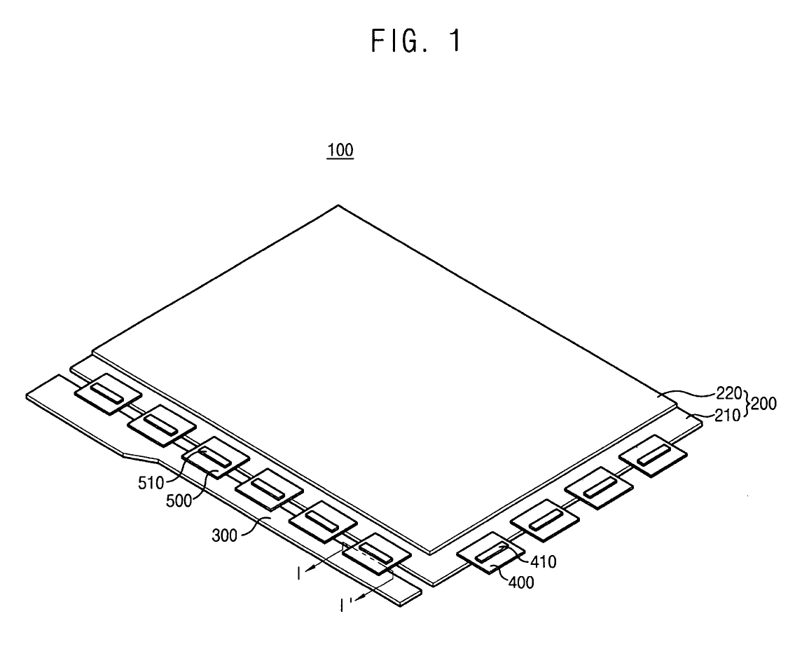

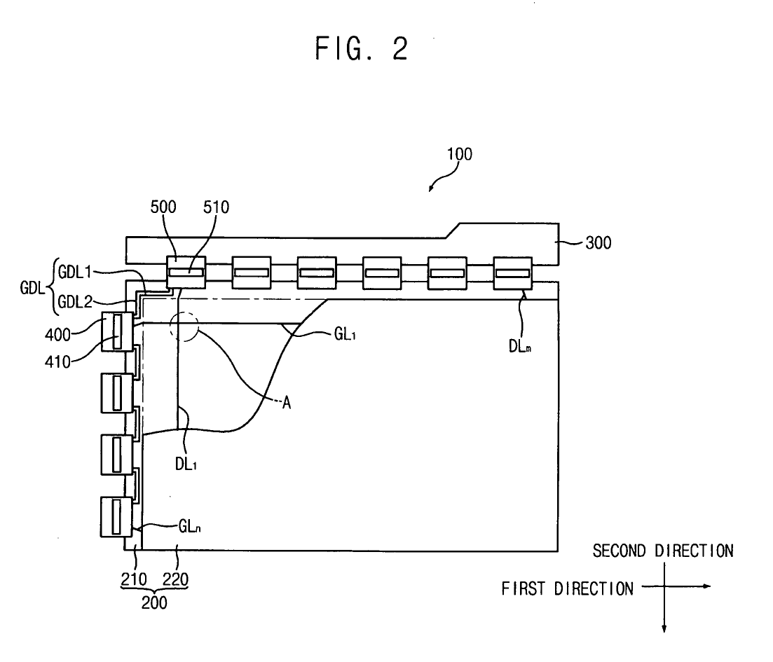

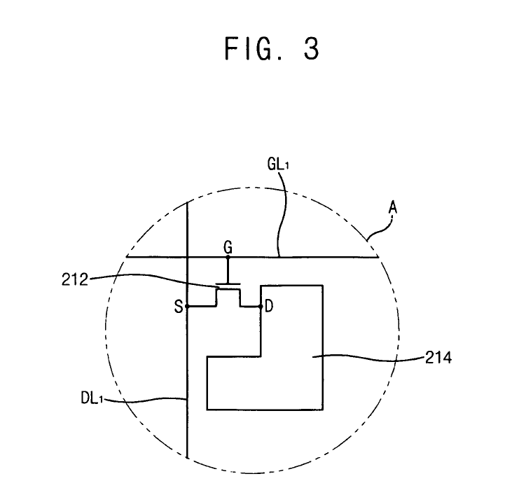

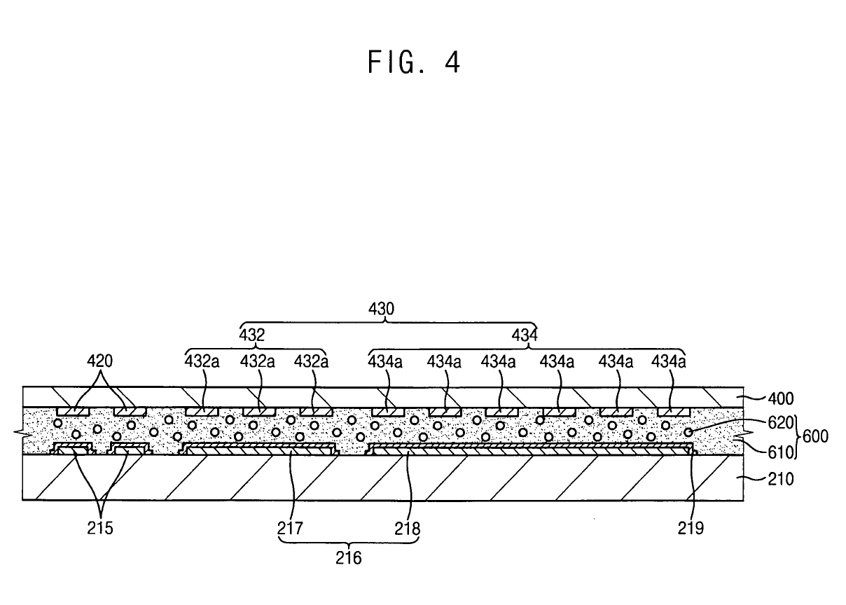

FIG. 1 is a perspective view illustrating an exemplary embodiment of a liquid crystal display (“LCD”) device. FIG. 2 is a plan view illustrating the LCD device in FIG. 1. FIG. 3 is an enlarged view illustrating a portion ‘A’ in FIG. 2, and FIG. 4 is a cross-sectional view taken along a line I-I′ in FIG. 1.

Referring to FIGS. 1 through 4, an LCD device 100 includes an LCD panel 200, a printed circuit board (“PCB”) 300, a plurality of first flexible printed circuits (“FPCs”) 400, a plurality of second FPCs 500 and an anisotropic conductive film (“ACF”) 600.

The LCD panel 200 includes a thin film transistor (“TFT”) substrate 210, a color filter substrate 220, and a liquid crystal layer (not shown) disposed between the TFT substrate 210 and the color filter substrate 220.

The TFT substrate 210 includes a plurality of gate lines GL extended along a first direction, such as from a first side of the TFT substrate 210 corresponding to the first FPCs 400 to an opposite second side of the TFT substrate 210, and a plurality of data lines DL extended along a second direction, such as from a third side of the TFT substrate 210 corresponding to the second FPCs 500 to an opposite fourth side of the TFT substrate 210. The first direction of the gate lines GL is substantially perpendicular to the second direction of the data lines DL. The TFT substrate 210 includes n-number of gate lines GL and m-number of data lines DL, wherein ‘n’ and ‘m’ are natural numbers. In other words, the TFT substrate 210 includes first through n-th gate lines GL1 through GLn, and first through m-th data lines DL1 through DLm.

The TFT substrate 210 further includes a plurality of TFTs 212 corresponding to a switching device and a plurality of pixel electrodes 214. Each of the TFTs 212 and each of the pixel electrodes 214 are disposed within a region defined by two adjacent data lines DL and two adjacent gate lines GL.

Each of the TFTs 212 includes a gate electrode ‘G’ that is electrically connected to one of the gate lines GL, a source electrode ‘S’ that is electrically connected to one of the data lines DL, and a drain electrode ‘D’ that is electrically connected to one of the pixel electrodes 214.

The pixel electrodes 214 include an optically transparent and electrically conductive material. The pixel electrodes 214 include, for example, indium tin oxide (“ITO”), indium zinc oxide (“IZO”), etc.

The color filter substrate 220 includes a color filter layer having a plurality of red color filters, a plurality of green color filters, and a plurality of blue color filters. The color filter substrate 220 further includes a common electrode (not shown) formed on the color filter layer.

When a gate signal is applied to the gate electrode ‘G’, the TFT 212 is turned on to apply a data signal to the pixel electrode 214 to generate electric fields between the pixel electrode 214 and the common electrode in the color filter substrate 220, so that an arrangement of liquid crystal molecules of the liquid crystal layer is altered to change optical transmittance. Therefore, an image is displayed on the LCD panel 200.

The PCB 300 generates a gate driving control signal for controlling the gate lines GL1, GL2, . . . , GLn, and a data driving control signal for controlling the data lines DL1, DL2, . . . , DLm. The PCB 300 is electrically connected to the LCD panel 200 through the second FPCs 500.

The m-number of data lines DL1, DL2, . . . , DLm may be divided into a plurality of blocks, and the second FPCs 500 drive each block of the data lines DL1, DL2, . . . , DLm, respectively. Within this embodiment, the data lines DL1, DL2, . . . , DLm are divided into six blocks, and six second FPCs 500 drive the six blocks, respectively, although it should be understood that alternate numbers of blocks may be utilized within this embodiment.

Each of the second FPCs 500 includes a data driving chip 510 that applies a data driving signal to the data lines DL1, DL2, . . . , DLm. At least one of the second FPCs 500 includes signal wiring (not shown) for transferring a signal provided by the PCB 300 to the TFT substrate 210.

The gate lines GL1, GL2, . . . GLn are also divided into a plurality of blocks, and the first FPCs 400 drive the blocks, respectively. Within this embodiment, the gate lines GL1, GL2, . . . GLn are divided into four blocks, and four first FPCs 400 drive each block. Each of the first FPCs 400 includes a gate driving chip 410 that applies a gate driving signal to the gate lines GL1, GL2, . . . , GLn.

The first and second FPCs 400 and 500 may be embodied through a chip on film (“COF”) or a tape carrier package (“TCP”).

The TFT substrate 210 further includes a first gate driving control signal line GDL1 and a second gate driving control signal line GDL2 for applying a gate driving control signal generated by the PCB 300 and the first gate driving control signal line GDL1 and the second gate driving control signal line GDL2 are provided from the signal line of the second FPC 500 to the first FPC 400. The first and second gate driving control signal lines GDL1 and GDL2 are formed at a corner of the TFT substrate 210. The gate driving control signals generated by the PCB 300 are applied to the first FPCs 400 in sequence through the first and second gate driving control signal lines GDL1 and GDL2.

The gate driving control signals include a gate on signal Von for turning on the TFT 212 that is electrically connected to the gate lines GL1, GL2, . . . GLn, and a gate off signal Voff for turning off the TFT 212. The gate on signal Von is transferred through the first gate driving control signal line GDL1, and the gate off signal Voff is transferred through the second gate driving control signal line GDL2.

The gate driving control signals may further include a gate clock signal PV, an output enable signal OE, a scan start signal STV, etc., and the TFT substrate 210 may thus include further gate driving control signal lines GDL in addition to the first and second gate driving control signal lines GDL1 and GDL2 for transferring the above-mentioned additional signals.

The first FPCs 400 are electrically connected to the TFT substrate 210 through the ACF 600 where the first FPCs 400 overlap the TFT substrate 210, and as clearly shown in FIG. 4. The TFT substrate 210 includes a plurality of gate pads 215 and a plurality of gate driving control signal pads 216. Although two gate pads 215 and two gate driving control signal pads 216 are shown, it should be understood that an alternate number of gate pads 215 and gate driving control signal pads 216 would also be within the scope of these embodiments. The gate pads 215 are electrically connected to the gate lines GL1, GL2, . . . , GLn, respectively, and the gate driving control signal pads 216 are electrically connected to the gate driving control signal lines GDL. The gate driving control signal pads 216 includes a first pad 217 and a second pad 218. The first pad 217 is electrically connected to the first gate driving control signal line GDL1, and the second pad 218 is electrically connected to the second gate driving control signal line GDL2.

The first FPC 400 further includes a plurality of gate signal terminals 420 and a plurality of gate driving terminals 430. Although a particular number of gate signal terminals 420 and gate driving terminals 430 are illustrated, it should be understood that alternate numbers of gate signal terminals 420 and gate driving terminals 430 would be within the scope of these embodiments. The gate signal terminals 420 are electrically connected to the gate pads 215 of the TFT substrate 210, and the gate driving terminals are electrically connected to the gate driving control signal pads 216 of the TFT substrate 210. The gate driving terminals 430 include a first terminal 432 that is electrically connected to the first pad 217, and a second terminal 434 that is electrically connected to the second pad 218.

In the illustrated embodiment, the first terminal 432 includes a plurality of first sub terminals 432a connected to each other, and the second terminal 434 includes a plurality of second sub terminals 434a connected to each other.

The ACF 600 includes a resin 610 for combining the TFT substrate 210 and the first FPC 400 and a plurality of conducting balls 620 distributed in the resin 610. A thermo setting resin may be employed as the resin 610, and the thermo setting resin 610 is hardened when heated and compressed. The conducting balls 620 are electrically connected to each other to electrically connect the pads 215, 216 to the terminals 420, 430, respectively, when the resin 610 is heated and compressed.

The gate pads 215 and the gate driving control signal pads 216 optionally additionally include a thin film 219 formed thereon. The thin film 219 includes optically transparent and electrically conductive material such as, but not limited to, indium tin oxide (“ITO”), indium zinc oxide (“IZO”), etc. The thin film 219 protects the gate pads 215 and the gate driving control signal pads 216.

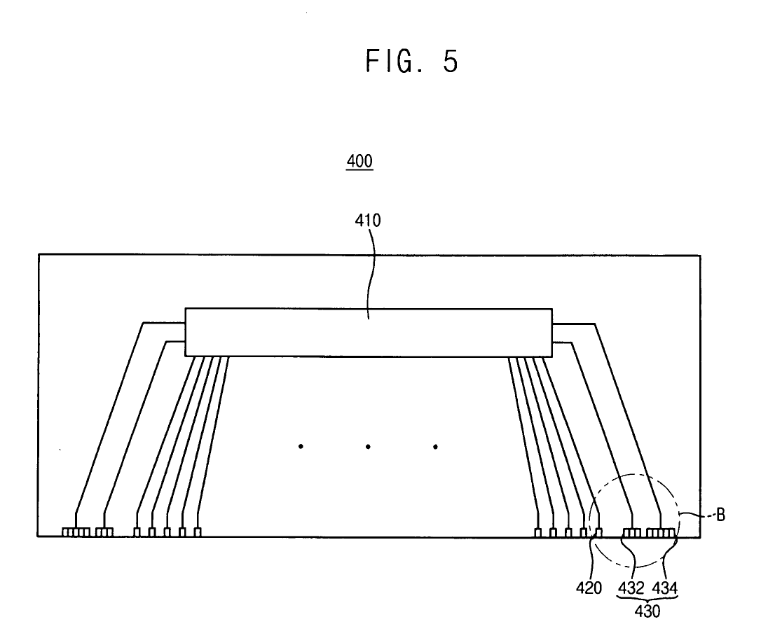

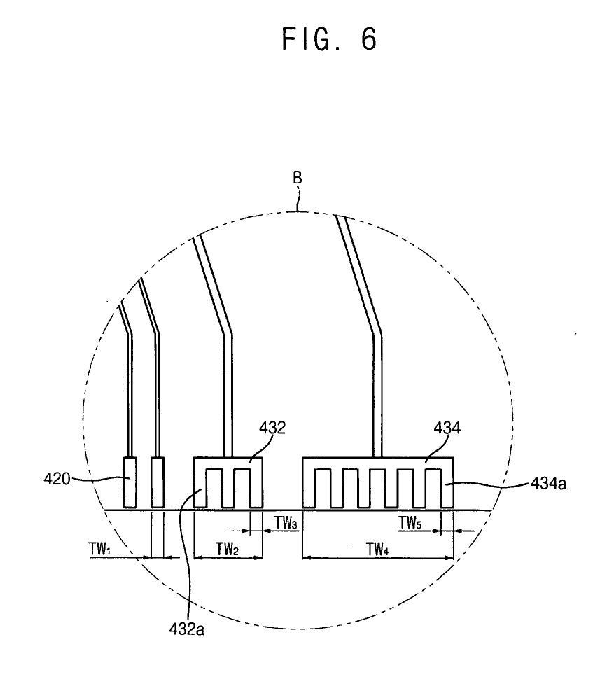

FIG. 5 is a plan view illustrating the first FPC 400 of FIG. 1, and FIG. 6 is an enlarged view illustrating portion ‘B’ in FIG. 5.

Referring to FIGS. 4, 5 and 6, the first FPCs 400 include the gate driving chips 410 and the gate signal terminals 420 corresponding to the gate pads 215 of the TFT substrate 210. Each of the gate signal terminals 420 are substantially equally wide, and the gate signal terminals 420 are arranged along a width-wise direction by a constant distance, that is, they are evenly spaced within each first FPC 400. The gate signal terminals 420 have a first terminal width TW1.

Each first FPC 400 further includes the gate driving terminals 430 corresponding to the gate driving signal control pads 216 of the TFT substrate 210. The gate driving terminals 430 include the first terminal 432 for transferring the gate on signal Von, and the second terminal 434 for transferring the gate off signal Voff. The first terminal 432 has a second terminal width TW2 that is greater than the first terminal width TW1. The first terminal 432 includes at least two first sub terminals 432a that are electrically connected to each other. The first terminal 432 may include a connecting portion from which the first sub terminals 432a depend. While three first sub terminals 432a are illustrated, it should be understood that any alternate number of first sub terminals 432a would be within the scope of these embodiments. Each of the first sub terminals 432a are substantially equivalently wide. In other words, each of the first sub terminals 432a has a third terminal width TW3. The first sub terminals 432a are arranged along a width-wise direction within each of the first FPCs 400. In the illustrated embodiment, the third terminal width TW3 of the first sub terminals 432a is, for example, substantially the same as the first terminal width TW1 of the gate signal terminals 420.

By example only, the gate pad 215 may have a width of about 50 μm, and the first pad 217 may have a width of about 250 μm, so that the gate signal terminal 420 corresponding to the gate pad 215 has the first terminal width TW1 of about 50 μm, and the first terminal 432 has the second terminal width TW2 of about 250 μm. Thus, in this example, the width of the gate pad 215 is approximately the same as the first terminal width TW1, and the width of the first pad 217 is approximately the same as the second terminal width TW2. The first terminal 432 includes three first sub terminals 432a each having the third terminal width TW3 of about 50 μm, so that the first sub terminals 432a are spaced apart by a distance of about 50 μm.

The second terminal 434 of the gate driving terminal 430 corresponds to the second pad 218 of the gate driving control signal pad 216. The second terminal 434 has a fourth terminal width TW4 that is greater than the second terminal width TW2 of the first terminal 432. The second terminal 434 includes at least two second sub terminals 434a electrically connected to each other. The second terminal 434 may include a connecting portion from which the second sub terminals 434a depend from. While six second sub terminals 434a are illustrated, it should be understood that any alternate number of second sub terminals 434a would be within the scope of these embodiments. The second sub terminals 434a are arranged in parallel along a width-wise direction within each of the first FPCs 400. Each of the second sub terminals 434a has a fifth terminal width TW5. The fifth terminal width TW5 is, for example, substantially the same as the first terminal width TW1 of the gate signal terminals 420 and thus also substantially the same as the third terminal width TW3 of the first sub terminals 432a.

By example only, the gate pad 215 may have a width of about 50 μm, and the second pad 218 may have a width of about 550 μm, so that the gate signal terminal 420 corresponding to the gate pad 215 has the first terminal width TW1 of about 50 μm, and the second terminal 434 has the fourth terminal width TW4 of about 550 μm. Thus, in this example, the width of the gate pad 215 is approximately the same as the first terminal width TW1, and the width of the second pad 218 is approximately the same as the fourth terminal width TW4. The second terminal 434 includes six second sub terminals 434a each having the fifth terminal width TW5 of about 50 μm, so that the second sub terminals 434a are spaced apart by a distance of about 50 μm.

As described above, when the gate driving terminals 430, each having a wider width TW2, TW4 than a width TW1 of each of the gate signal terminals 420, are divided into a plurality of sub terminals 432a, 434a, a contact stability between the LCD panel 200 and each of the first FPCs 400 is increased.

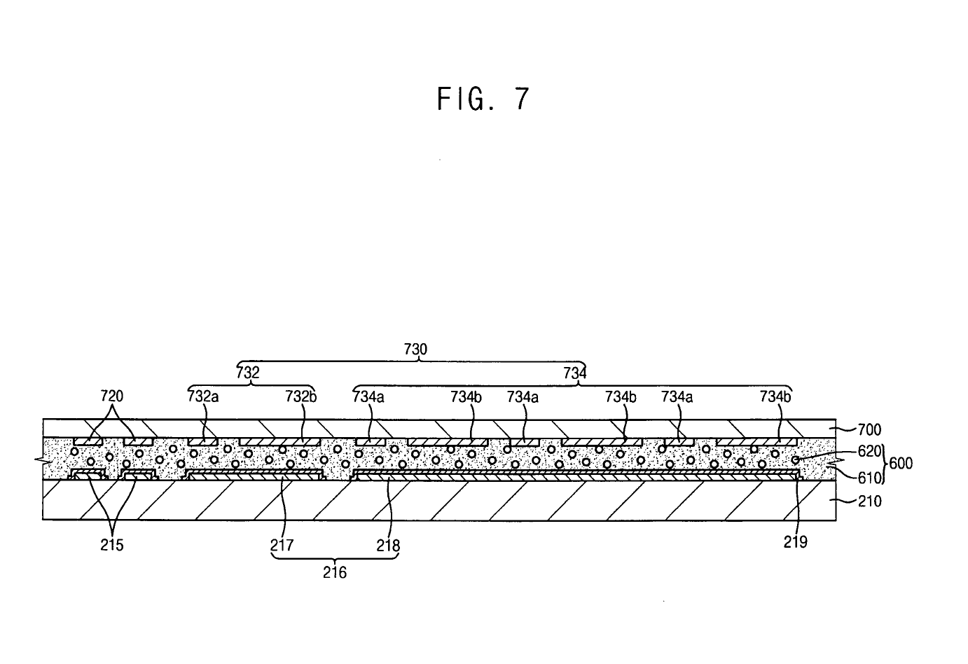

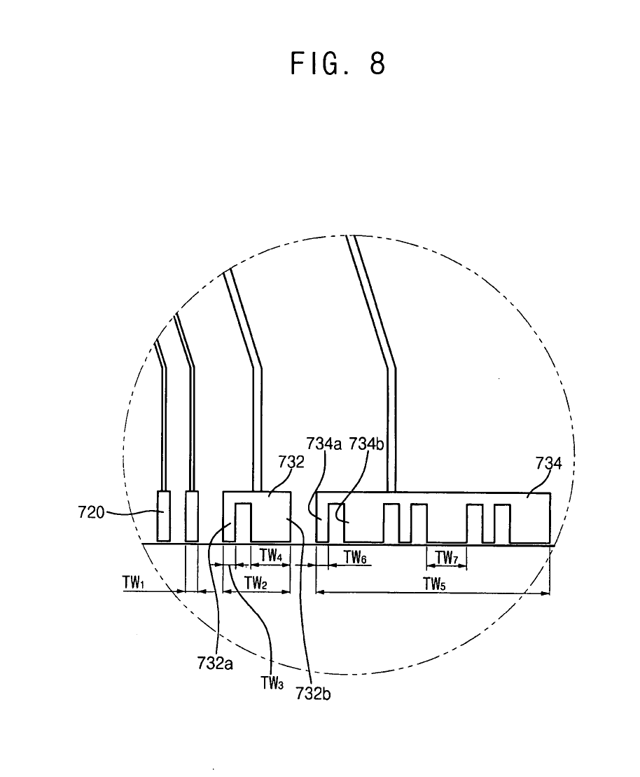

FIG. 7 is a cross-sectional view illustrating another exemplary embodiment of an LCD device, and FIG. 8 is an enlarged view illustrating a portion of a first flexible printed circuit 700 in FIG. 7. The LCD device of the embodiments of FIGS. 7-8 is substantially the same as in the embodiments in FIGS. 1 through 6 except for a first FPC 700 instead of the first FPC 400. Thus, the same reference numerals will be used to refer to the same or like parts as those described in the embodiments of FIGS. 1-6 and any further explanation concerning the above elements will be omitted.

Referring to FIGS. 7 and 8, a first FPC 700 includes gate signal terminals 720 electrically connected to the gate pads 215 of the TFT substrate 210, respectively. Each of the gate signal terminals 720 has substantially the same width as the other gate signal terminals 720. Each of the gate signal terminals 720 has a first terminal width TW1. The gate signal terminals 720 are arranged along a width-wise direction by a uniform distance, that is, the gate signal terminals 720 are evenly spaced within the first FPC 700.

The first FPC 700 also includes gate driving terminals 730 that are electrically connected to the gate driving control signal pad 216. The gate driving terminals 730 include a first terminal 732 for transferring the gate on signal Von. The first terminal 732 corresponds to the first pad 217. The first terminal 732 has a second terminal width TW2 that is greater than the first terminal width TW1 of each of the gate signal terminals 720. The first terminal 732 includes a first sub terminal 732a and a second sub terminal 732b. The first and second sub terminals 732a and 732b are electrically connected to each other. The first terminal 732 may include a connecting portion from which the first sub terminal 732a and the second sub terminal 732b depend. While two sub terminals are illustrated, it should be understood that any alternate number of sub terminals would be within the scope of these embodiments. The first sub terminal 732a has a third terminal width TW3, and the second sub terminal 732b has a fourth terminal width TW4 that is greater than third terminal width TW3 of the first sub terminal 732a. The fourth terminal width TW4 of the second sub terminal 732b is, for example, three times greater than the third terminal width TW3 of the first sub terminal 732a.

By example only, the gate pad 215 may have a width of about 50 μm, and the first pad 217 may have a width of about 250 μm, so that the gate signal terminal 720 has the first terminal width TW1 of about 50 μm and the first terminal 732 corresponding to the first pad 217 has the second terminal width TW2 of about 250 μm. Thus, in this example, the width of the gate pad 215 is approximately the same as the first terminal width TW1, and the width of the first pad 217 is approximately the same as the second terminal width TW2. The first sub terminal 732a of the first terminal 732 has the third terminal width TW3 of about 50 μm, and the second sub terminal 732b of the first terminal 732 has the fourth terminal width TW4 of about 150 μm. The first and second sub terminals 732a and 732b are spaced apart from each other by a distance of about 50 μm.

The gate driving terminal 730 further includes a second terminal 734 for transferring the gate off signal Voff. The second terminal 734 corresponds to the second pad 218 of the TFT substrate 210. The second terminal 734 has a fifth terminal width TW5 that is greater than the second terminal width TW2 of the first terminal 732. The second terminal 734 includes third sub terminals 734a and fourth sub terminals 734b electrically connected to each other. The second terminal 734 may include a connecting portion from which the third sub terminals 734a and the fourth sub terminals 734b depend. While three third sub terminals 734a and three fourth sub terminals 734b are illustrated, it should be understood that any alternate number of sub terminals would be within the scope of these embodiments. The third and fourth sub terminals 734a and 734b may alternate with each other. The second terminal 734 may, in one example, include a connecting portion from which a third sub terminal 734a, a fourth sub terminal 734b, a third sub terminal 734a, a fourth sub terminal 734b, a third sub terminal 734a, and a fourth sub terminal 734b sequentially extend.

The third sub terminals 734a each have a sixth terminal width TW6, and the fourth sub terminals 734b each have a seventh terminal width TW7 that is greater than the sixth terminal width TW6. The sixth terminal width TW6 of the third sub terminals 734a is, for example, substantially the same as the first terminal width TW1 of each of the gate signal terminals 720. The seventh terminal width TW7 is substantially three times greater than the sixth terminal width TW6.

By example only, the gate pad 215 may have a width of about 50 μm, and the second pad 218 may have a width of about 850 μm. Therefore, the gate signal terminal 720 corresponding to the gate pad 215 has the first terminal width TW1 of about 50 μm, and the second terminal 734 corresponding to the second pad 218 has the fifth terminal width TW5 of about 550 μm. Thus, in this example, the width of the gate pad 215 is approximately the same as the first terminal width TW1, and the width of the second pad 218 is approximately the same as the fifth terminal width TW5. The third sub terminals 734a each have the sixth terminal width TW6 of about 50 μm, and the fourth sub terminals 734b each have the seventh terminal width TW7 of about 150 μm. The third and fourth sub terminals 734a and 734b are spaced apart form each other by a distance of about 50 μm.

As described above, within this embodiment, the gate driving terminals 730, having wider widths TW2, TW5 than the width TW1 of each of the gate signal terminals 720, are divided into at least two sub terminal groups, e.g. 732a, 732b and 734a, 734b, having different widths from each other to enhance stability of contact through a sub terminal group having a relatively narrower width, e.g. 732a, 734a, and contact resistivity through a sub terminal group having a relatively wider width, e.g. 732b, 734b.

FIG. 9 is an exploded perspective view illustrating another exemplary embodiment of an LCD device according to the present invention. The LCD device may include any one of the LCD panels or alternate embodiments previously described and a backlight assembly. Therefore, any further explanation of the LCD panel and its related components will be omitted.

Referring to FIG. 9, an LCD device 800 further includes a backlight assembly 900 disposed under the LCD panel 200, that is, facing the TFT substrate 210 rather than the color filter substrate 220. The backlight assembly 900 provides the LCD panel 200 with light. The backlight assembly 900 includes a lamp unit 910, an optical member 920, and a receiving container 930.

The lamp unit 910 includes at least one lamp 912 and a lamp cover 914. The lamp 912 generates light, and the lamp cover 914 reflects light generated by the lamp 912 towards the optical member 920. The lamp unit 910 is disposed at an edge portion of the receiving container 930.

For example, a cold cathode fluorescent lamp (“CCFL”) having a cylindrical shape may be employed as the lamp 912. When a driving voltage is applied to the lamp 912, the lamp 912 generates light. The lamp cover 914 includes a material having a relatively high optical reflectivity. The lamp cover 914 includes, for example, polyethylene terephthalate (“PET”). Alternatively, the lamp cover 914 may include a reflection layer having a material with a relatively high reflectivity, which is coated on inner surface of the lamp cover 914. The lamp cover 914 reflects light that is received by the lamp cover 914 toward the optical member 920 to enhance light-using efficiency.

The optical member 920 includes a light guide plate 922, a reflection sheet 924, and at least one optical sheet 926. The light guide plate 922 guides light towards the LCD panel 200. The reflection sheet 924 is disposed under the light guide plate 922 to reflect light that is leaked from the light guide plate 922 towards the light guide plate 922. The light guide plate 922 is positioned between the reflection sheet 924 and the optical sheet 926. The optical sheet 926 enhances optical characteristics of light that exits the light guide plate 922.

The lamp unit 910 is disposed at one side of the light guide plate 922, so that light generated by the lamp unit 910 enters the light guide plate 922 through a side surface of the light guide plate 922. Light that enters the light guide plate 922 exits through an upper surface of the light guide plate 922. The light guide plate 922 optionally has diffusive reflecting patterns or prism patterns formed on a lower surface that is opposite to the upper surface in order to increase an amount of light exiting through the upper surface. The light guide plate 922 includes, for example, polymethylmethacrylate (“PMMA”) having a relatively high optical transmissivity.

The reflection sheet 924 reflects light that is leaked from the light guide plate 922 back towards the light guide plate 922. The reflection sheet 924 includes, for example, polyethylene terephthalate (“PET”) or polycarbonate (“PC”).

The optical sheet 926 enhances optical properties of light that exits the light guide plate 922. The optical sheet 926 includes, for example, a prism sheet that enhances a front-view luminance. The optical sheet 926 further includes, for example, a light-diffusing sheet. In alternate embodiments, the optical sheet 926 may include more or less optical enhancing sheets, or the optical sheet 926 may be excluded from the optical member 920.

The receiving container 930 includes a bottom plate 932 and a sidewall 934 extended from edge portions of the bottom plate 932. The receiving container 930 receives the lamp unit 910 and the optical member 920.

In the illustrated embodiment, the LCD device 800 includes, for example, the backlight assembly 900 corresponding to an edge illumination type backlight assembly. Alternatively, the LCD device 800 may include a direct illumination type backlight assembly having a plurality of lamps arranged over the bottom plate 932 of the receiving container 930, where the plurality of lamps are in parallel with each other.

The LCD device 800 further includes a top chassis 950 for fixing the LCD panel 200 within the LCD device 800. The top chassis 950 surrounds edge portions of the LCD panel 200 and the top chassis 950 is combined with the receiving container 930 to fix the LCD panel 200 to the receiving container 930. The top chassis 950 protects the LCD panel 200.

The LCD device 800 may further include a mold frame 960 disposed between the optical member 920 and the LCD panel 200. The mold frame 960 fixes edge portions of the optical member 920 and guides the LCD panel 200 to be fixed at a proper position.

According to the embodiments and alternate embodiments described herein, the gate driving terminals, e.g., 430, 730, having a wider width than each of the gate signal terminals, e.g. 420, 720, are divided into a plurality of sub terminals to enhance stability of contact between the LCD panel 200 and each of the first FPCs, e.g., 400, 700.

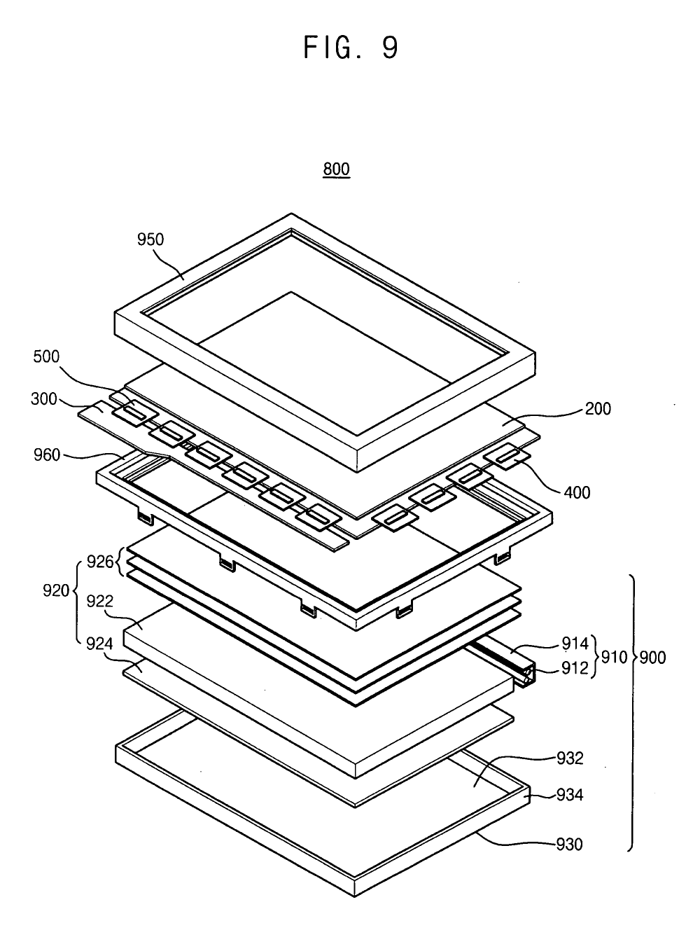

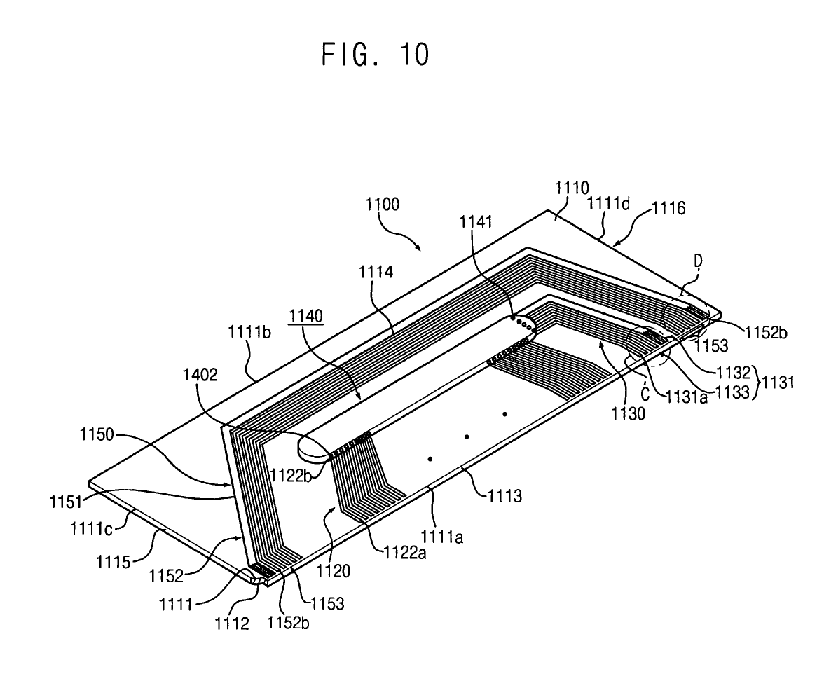

Additionally, when the gate driving terminals, e.g. 430, 730, are divided into a plurality of sub terminals having different widths, the stability contact is enhanced and contact resistance is reduced. Furthermore, by providing the gate driving terminals, e.g. 430, 730, with a plurality of sub terminals, resin-extruding paths are formed between the sub terminals thereby allowing resin of the ACF to flow therein, thus increasing stability of the connection between the FPCs and the display panel. The resin-extruding paths as illustrated include slots formed within the gate driving terminals. The slots divide the gate driving terminals into the plurality of sub terminals. Turning now with general reference to FIGS. 10-22, the application of resin-extruding paths for increasing the stability of a connection between an ACF and a signal transmission film will be further described. The signal transmission film may be, for example, the FPCs described above, where the FPC may be embodied through a tape carrier package, as will be further described below. Alternate applications for the signal transmission film having an improved connection to an anisotropic conductive film via the resin-extruded path are also within the scope of these embodiments. A signal transmission film in accordance with the present invention includes a body and a conductive pattern.

The conductive pattern is formed on the body, and the conductive pattern makes contact with an anisotropic conductive film (“ACF”). The ACF includes a reflowable resin and micro-conductive balls contained in the resin of the ACF.

The conductive pattern includes a resin-extruding path. The resin-extruding path is disposed at a portion that makes contact with the ACF of the conductive pattern.

Each of the resin-extruding paths, for example, has various shapes in a plan view, and is arranged in various ways on the portion of the conductive pattern. For example, the resin-extruding path may have a groove shape, a stripe shape opening, a fork shape, a branch shape, etc.

In one embodiment, the resin-extruding path is formed in a direction perpendicular to a peripheral portion of the conductive pattern. Alternatively, the resin-extruding path may be inclined relative to the peripheral portion of the conductive pattern.

The body on which the conductive pattern is formed may include a flexible material.

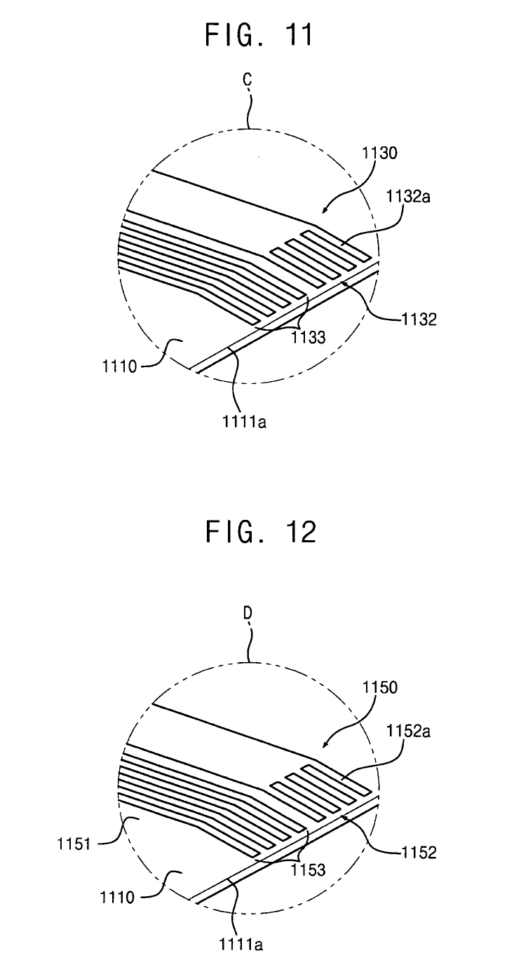

FIG. 10 is a perspective view illustrating an exemplary embodiment of a signal transmission film. FIG. 11 is an enlarged view illustrating portion ‘C’ in FIG. 10. FIG. 12 is an enlarged view illustrating portion ‘D’ in FIG. 10.

Referring to FIGS. 10, 11, and 12, a signal transmission film 1100 includes a base substrate 1110, an output line group 1120, an input line group 1130, a driver integrated circuit (“IC”) 1140, and a by-pass line group 1150.

The base substrate 1110 corresponds to a thin flexible film. The base substrate 1110, for example, has a rectangular shape in a plan view. Therefore, the base substrate 1110 has a first side 1113, a second side 1114 that is opposite to the first side 1113 and may be parallel to the first side 1113, a third side 1115, and a fourth side 1116 that is opposite to the third side 1115 and may be parallel to the third side 1115. The first and second sides 1113 and 1114 are longer than the third and fourth sides 1115 and 1116. Other shapes of the base substrate 1110 would also be within the scope of these embodiments. The base substrate 1110 includes a first face 1111 and a second face 1112 that is opposite the first face 1111.

The base substrate 1110 has, for example, four peripheral portions because of the rectangular film shape. The four peripheral portions, hereinafter, referred to as a first peripheral portion 1111a, a second peripheral portion 1111b, a third peripheral portion 1111c, and a fourth peripheral portion 1111d. The first peripheral portion 1111a is opposite the second peripheral portion 1111b, and the third peripheral portion 1111c is opposite the fourth peripheral portion 1111d. The first, second, third, and fourth peripheral portions 1111a, 1111b, 1111c, and 1111d correspond to the first, second, third, and fourth sides 1113, 1114, 1115, and 1116, respectively. The output line group 1120 is disposed on the first face 1111 of the base substrate 1110, and the output line group 1120 has, for example, 256 output lines 1122, not all of which are illustrated for simplicity.

Each of the output lines 1122 has a stripe shape and is extended from the first peripheral portion 1111a of the first face 1111 toward the second peripheral portion 1111b. Each of the output lines 1122 has a first end portion 1120a and a second end portion 1120b that is opposite to the first end portion 1120a. Each of the first end portions 1120a of the signal output lines 1122 is adjacent to the first peripheral portion 1111a. Each of the second end portions 1120b of the signal output lines 1122 is disposed at a center portion of the first face 1111 of the base substrate 1110.

The signal output lines 1122 may be bent towards the center portion of the first face 1111. In other words, the first end portion 1120a of each of the signal output lines 1122 is extended to be parallel with the third and fourth sides 1115 and 1116, and then bent towards the driver IC 1140 that is disposed at the center portion of the first face 1111. The driver IC 1140 may extend longitudinally parallel with the first and second sides 1113 and 1114 such that the output lines 1122 connect to a side of the driver IC 1140 closest to the first side 1113.

A driving signal for displaying an image is applied to a display panel through the signal output lines 1122.

The input line group 1130 is disposed on the first face 1111 of the base substrate 1110. The input line group 1130 has a plurality of input lines 1131.

Each of the input lines 1131 has a stripe shape and is extended from the first peripheral portion 1111a on the first face 1111 toward a side of the driver IC 1140 that faces the fourth side 1116.

The input line group 1130 and the output line group 1120 are spaced apart from each other to prevent an electrical short from occurring between the input line group 1130 and the output line group 1120.

Each of the signal input lines 1131 has a first end portion and a second end portion that is opposite to the first end portion. The first end portion of each of the input lines 1131 is disposed adjacent to the first peripheral portion 1111a. Each of the second end portions of the signal input lines 1131 is disposed at a center portion of the first face 1111 of the base substrate 1110, so that the second end portions are electrically connected to the driver IC 1140 disposed at the center portion of the first face 1111 such as at the side of the driver IC 1140 closest to the fourth side 1116.

A driving signal generated from an external PCB is applied to the driver IC 1140 disposed on the base substrate 1100 through the input lines 1131. The driving signal includes a first driving signal having a first voltage level and a second driving signal having a second voltage level that is lower than the first voltage level. For example, the first driving signal may correspond to a power signal and the second driving signal may correspond to a timing signal.

The signal input lines 1131 include a first signal input line 1132 and second signal input lines 1133. The first driving signal is applied to the driver IC 1140 through the first signal input line 1132. The second driving signal is applied to the driver IC 1140 through the second signal input lines 1133. The first signal input line 1132 has a first width, and each of the second signal input lines 1133 has a second width that is smaller than the first width. The first end portion of the first signal input line 1132 is pronged to form a fork shape. The portion of the first signal input line 1132 that extends to the second end portion connected to the driver IC 1140 is not pronged, and therefore has the first width that is greater than the second width of each of the second signal input lines 1133. Each of the prongs of the first signal input line 1132 may have the same width as the second width of each of the second signal input lines 1133.

The by-pass line group 1150 is disposed on the first face 1111 of the base substrate 1110 of the signal transmission film 1100. When at least two signal transmission films 1100 are electrically coupled to a display panel, the driving signal is transferred from one signal transmission film to another signal transmission film through the by-pass line group 1150 and the display panel.

The by-pass line group 1150 has a plurality of by-pass lines 1151. The by-pass line group 1150 includes a first by-pass line 1152 and second by-pass lines 1153. The by-pass line group 1150 is spaced apart from the output line group 1120 and the input line group 1130 so as to prevent an electrical short from occurring there between. For example, the by-pass lines 1151 of the by-pass line group 1150 are first extended from a first sub portion of the first peripheral portion 1111a, which is adjacent to the fourth peripheral portion 1111d toward the second peripheral portion 1111b. Second, the by-pass lines 1151 are extended such that the by-pass lines 1151 are substantially in parallel with the second side 1114 and disposed between the driver IC 1140 and the second side 1114. Third, the by-pass lines 1151 are extended from adjacent the second peripheral portion 1111b toward a second sub portion of the first peripheral portion 1111a, which is adjacent to the third peripheral portion 1111c.

The first by-pass line 1152 has a first end portion 1152a and a second end portion 1152b that is opposite the first end portion 1152a. The first and second end portions 1152a and 1152b of the first by-pass line 1152 are disposed adjacent to the first peripheral portion 1111a of the base substrate 1110.

The first driving signal having the first voltage level is applied to the first by-pass line 1152 and the second driving signal having the second voltage level is applied to the second by-pass lines 1153.

A first width of the first by-pass line 1152 is larger than a second width of each of the second by-pass lines 1153 in a plan view. The first and second end portions 1152a and 1152b of the first by-pass line 1152 is pronged to form a fork shape. A central portion of the first by-pass line 1152 that extends adjacent the second peripheral portion 1111b is not pronged, and therefore has the first width that is greater than the second width of each of the second by-pass lines 1153. Each of the prongs of the first by-pass line 1152 within the first and second end portions 1152a and 1152b may have the same width as the second width of each of the second by-pass lines 1153.

The driver IC 1140 is disposed on the first face 1111 of the base substrate 1110. The driver IC 1140 includes a plurality of first bumps 1141 and a plurality of second bumps 1142, otherwise known as first and second sets of terminals 1141, 1142. While the first and second bumps 1141 and 1142 are disposed on a lower face of the driver IC 1140, and thus sandwiched between the driver IC 1140 and the first face 1111 of the base substrate 1110, for convenience, the first and second bumps 1141 and 1142 are illustrated in FIG. 1. The driving signal is applied to the second bumps 1142 of the driver IC 1140 through the signal input lines 1131. The second bumps 1142 are electrically connected to the signal input lines 1131. The driver IC 1140 processes the driving signal provided from the signal input lines 1131. The first bumps 1142 are electrically connected to the signal output lines 1122. The processed driving signal is applied to the signal output lines 1122 through a first bump 1141 of the driver IC 1140.

An anisotropic conductive film (“ACF”, such as shown in prior and later figures) is interposed between the signal transmission film 1100 and a portion of a signal line formed on the display panel. The ACF includes a resin having a flexible property and micro-conductive balls mixed with the resin.

A first portion of the ACF interposed between the first signal input line 1132 and the signal line of the display panel has a first adhesive strength. A second portion of the ACF interposed between the second signal input line 1133 and the signal line of the display panel has a second adhesive strength.

The first adhesive strength corresponds to a first contact area between the first signal input line 1132 and the signal line of the display panel, and the second adhesive strength corresponds to a second contact area between the second signal line 1133 and the signal line of the display panel. When the first contact area is larger than the second contact area, the second adhesive strength is greater than the first adhesive strength.

A third portion of the ACF is interposed between the first by-pass line 1152 and the signal line of the display panel and has a third adhesive strength. A fourth portion of the ACF is interposed between the second by-pass line 1153 and the signal line of the display panel and has a fourth adhesive strength.

The third adhesive strength corresponds to a third contact area between the first by-pass line 1152 and the signal line of the display panel, and the fourth adhesive strength corresponds to a fourth contact area between the second by-pass line 1153 and the signal line of the display panel. When the third contact area of the first by-pass line 1152 is larger than the fourth contact area of the second by-pass line 1153, the third adhesive strength is greater than the fourth adhesive strength.

Referring to FIG. 11, a first resin-extruding path 1132a is formed at a first end portion of the first signal input line 1132, thereby extruding the resin of the ACF along the first resin-extruding path 1132a. In detail, the first resin-extruding path 1132a may be formed at a lateral portion of the first signal input line 1132. The resin of the ACF is rapidly extruded through the first resin-extruding path 1132a so that the signal line of the display panel and the first signal input line 1132 are electrically connected with each other through the micro-balls of the ACF.

The first resin-extruding path 1132a, for example, is extended along a longitudinal direction of the first input signal line 1132 to form a fork shape. The first resin-extruding path 1132a is extended in a direction perpendicular to the first peripheral portion 1111a. In other words, the first end portion of the first input signal line 1132 is pronged to form a fork shape, and the first resin-extruding path 132 is also thus fork shaped, and includes the spaces between the prongs of the fork shape of the first end portion of the first input signal line 1132 for allowing the resin to flow therein.

Referring to FIG. 12, a first by-pass line 1152 of the by-pass line group 1150 is disposed on the first peripheral portion 1111a and has a second resin-extruding path formed at first end portion 1152a so as to extrude the resin in the ACF. The second resin-extruding path formed at first end portion 1152a is disposed at a lateral portion of the first by-pass line 1152. In one embodiment, the first end portion 1152a may be fork shaped, thus providing a complimentarily fork shaped second resin-extruding path such that the resin may flow between the prongs of the fork shaped first end portion 1152a. The resin in the ACF is externally extruded along the second resin-extruding path at the first end portion 1152a, so that the micro-balls in the resin of the ACF are electrically connected to the first by-pass line 1152 of the by-pass line group 1150.

The second resin-extruding path at first end portion 1152a is formed in a direction perpendicular to the second peripheral portion 1111b and the second resin-extruding path at first end portion 1152a has a fork shape to extrude the resin of the ACF rapidly. While a fork shape is illustrated, other shapes for the second resin-extruding path are within the scope of these embodiments. Furthermore, a third resin-extruding path, similar to the second resin-extruding path, may be formed at the second end portion 1152b of the first by-pass line 1152.

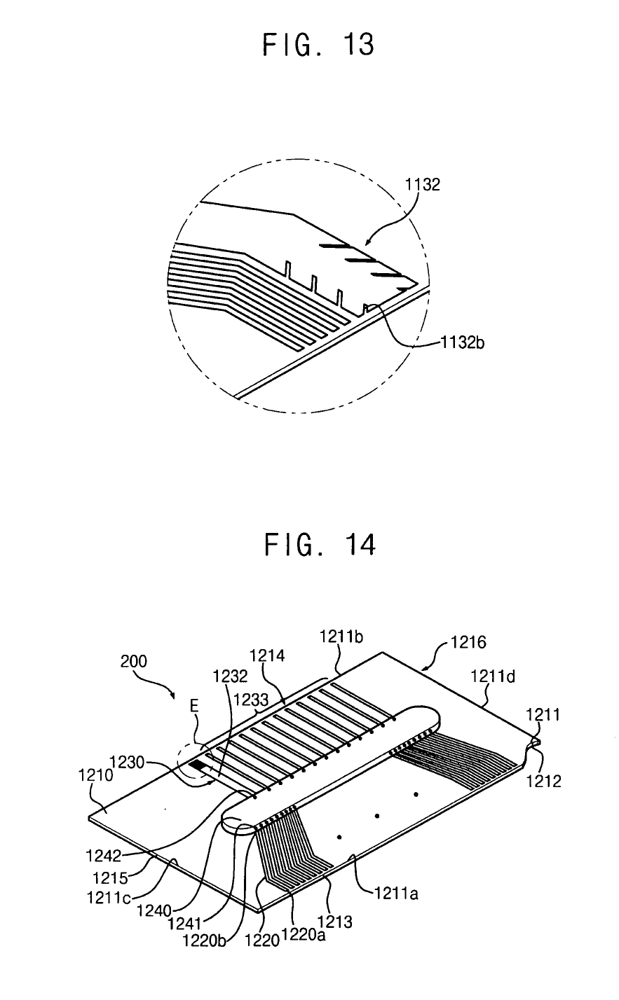

FIG. 13 is a perspective view illustrating another exemplary embodiment of a first resin-extruding path employable within the first signal input line 1132 of the input line group 1130 on the signal transmission film 1100.

Referring to FIG. 13, the first resin-extruding path 1132b forms an acute angle with respect to a longitudinal direction of the first signal input line 1132. That is, a first set of paths may extend acutely angularly from one side of the first signal input line 1132 facing the second signal input lines 1133, and a second set of paths may extend acutely angularly from a second side of the first signal input line 1132 facing the second by-pass lines 1153. Thus, the resin extruding path 1132b has a branch shape. Therefore, resin of the ACF may be extruded through the first resin-extruding path 1132b. Alternatively, the first resin-extruding portion 1132b may have various shapes, and may be arranged in various ways.

FIG. 14 is a perspective view illustrating another exemplary embodiment of a signal transmission film.

Referring to FIG. 14, a signal transmission film 1200 includes a base substrate 1210, an output line 1220, an input line 1230, and a driver IC 1240.

The base substrate 1210, for example, includes a flexible circuit board having a thin thickness. In this exemplary illustrated embodiment, the base substrate 1210 has a generally rectangular film shape, although other shapes would also be within the scope of these embodiments.

The base substrate 1210 includes a first face 1211, a second face 1212, and a plurality of first through fourth side faces 1213, 1214, 1215, and 1216.

When the base substrate 1210 has a rectangular film shape as shown, the base substrate 1210 has four peripheral portions. The four peripheral portions of the base substrate 1210 are defined as a first peripheral portion 1211a, a second peripheral portion 1211b, a third peripheral portion 1211c, and a fourth peripheral portion 1211d. The first peripheral portion 1211a and the third peripheral portion 1211c are opposite to the second peripheral portion 1211b and the fourth peripheral portion 1211d, respectively.

The output line 1220 is disposed on the first face 1211 of the base substrate 1210. The output line 1220 is extended from the first peripheral portion 1211a towards the driver IC 1240 disposed at a center portion of the base substrate 1210. The driver IC 1240 may extend longitudinally across the center portion of the base substrate 1210 so as to lie substantially parallel between the first and second side faces 1213, 1214. The first end portion of the signal output line 1220 is disposed adjacent to the first peripheral portion 1211a, and a second end portion opposite the first end portion is disposed at a center portion of the first face 1211.

While only a subset of the output lines 220 are illustrated for simplicity, 256 units of the output lines 1220 may be formed on the base substrate 1210, and the output lines 1220 are substantially in parallel with each other. The first end portion of the output lines 1220 is disposed substantially perpendicular to the first peripheral portion 1211a, while a second end portion of the output lines 220 is connected to the driver IC 1240.

The input lines 1230 are disposed on the first face 1211 of the base substrate 1210. The signal input lines 1230 have a stripe shape and are extended from the second peripheral portion 1211 b toward the driver IC 1240. The input lines 1230 are spaced apart from each other and from the output lines 220 to prevent an electrical short from occurring between the input lines 1230 and the output lines 1220.

The driver IC 1240 receives a driving signal provided from an external device such as a PCB through the input lines 1230.

The driving signal applied to the signal input lines 1230 includes a first driving signal having a first voltage level and a second driving signal having a second voltage level that is lower than the first voltage level.

The signal input lines 1230 include a first input line 1232 and second input lines 1233. The first driving signal is applied to the driver IC 1240 through the first input line 1232. The second driving signal is applied to the driver IC 1240 through the second input lines 1233.

The first input line 1232 receiving the first driving signal having a first voltage level has a first width. Each of the second signal input lines 1233 receiving the second driving signal having the second voltage level has a second width that is smaller than the first width.

The driver IC 1240 is disposed on the first face 1211 of the base body 1210. The driver IC 1240 includes first bumps 1241 and second bumps 1242, otherwise known as terminals. The second bumps 1242 of the driver IC 1240 are electrically coupled to the output line 1220. The first bumps 1241 of the driver IC 1240 is electrically coupled to the input line 1230. While the first and second bumps 1241 and 1242 are formed on a lower face of the driver IC 1240, and thus sandwiched between the driver IC 1240 and the first face 1211 of the base substrate 1210, for illustration, the first and second bumps 1241 and 1242 are shown in FIG. 5.

An anisotropic conductive film (“ACF”, as shown in other prior and following figures) is interposed between the signal line of a display device and the signal transmission film 1200 to connect the signal output line 1220 and the signal input line 1230. The ACF includes a resin and micro-conductive balls in the resin.

When the area of each of the signal input lines 1230 is increased, an amount of extrusion of the resin is decreased so that an electrical characteristic between the ACF and the signal input lines 1230 is also decreased.

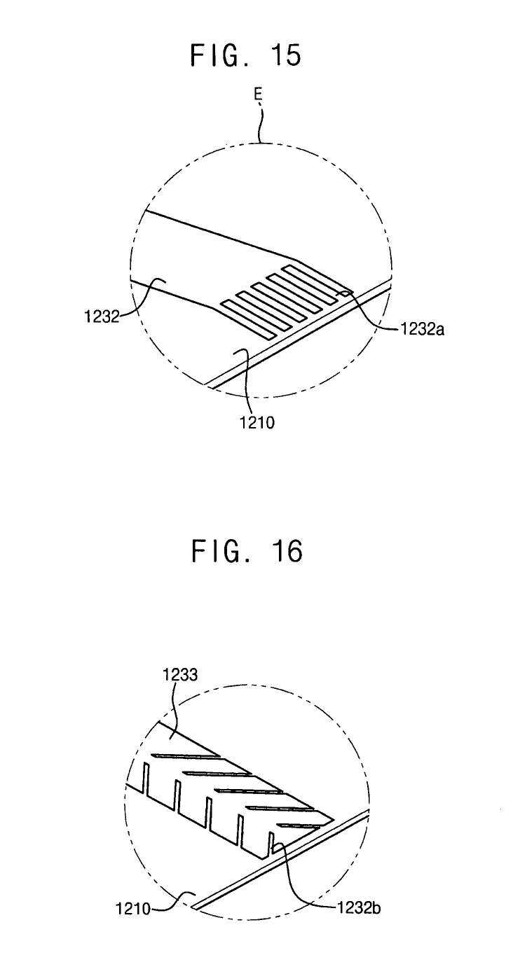

FIG. 15 is an enlarged view illustrating a portion ‘E’ in FIG. 14.

Referring to FIGS. 14 and 15, a resin-extruding path 1232a is formed on the first signal input line 1232 of the signal input line 1230 that is electrically contacted to the ACF to extrude the resin in the ACF.

In this exemplary embodiment, the resin of the ACF is externally extruded along the resin-extruding path 1232a formed within an end portion of the first signal input line 1232, so that the micro-conductive balls of the ACF make contact with the first signal input line 1232 of the signal input line 1230.

At least one resin-extruding path 1232a is formed on the first signal input line 1232 from the second peripheral portion 1211b extending in a direction towards the first peripheral portion 1211a. The resin-extruding path 1232a, for example, has a fork shape for allowing the resin of the ACF to flow between prongs of the fork shaped end portion of the first signal input line 1232. The resin-extruding path 1232a is formed in a direction perpendicular to the second peripheral portion 1211b. Also, the first signal input line 1232 has a first width that is greater than a width of each prong in a first end portion of the first signal input line 1232, in an area of the resin extruding path 1232a. Also, the first width of the first signal input line 1232 is greater than a second width of each of the second signal input lines 1233.

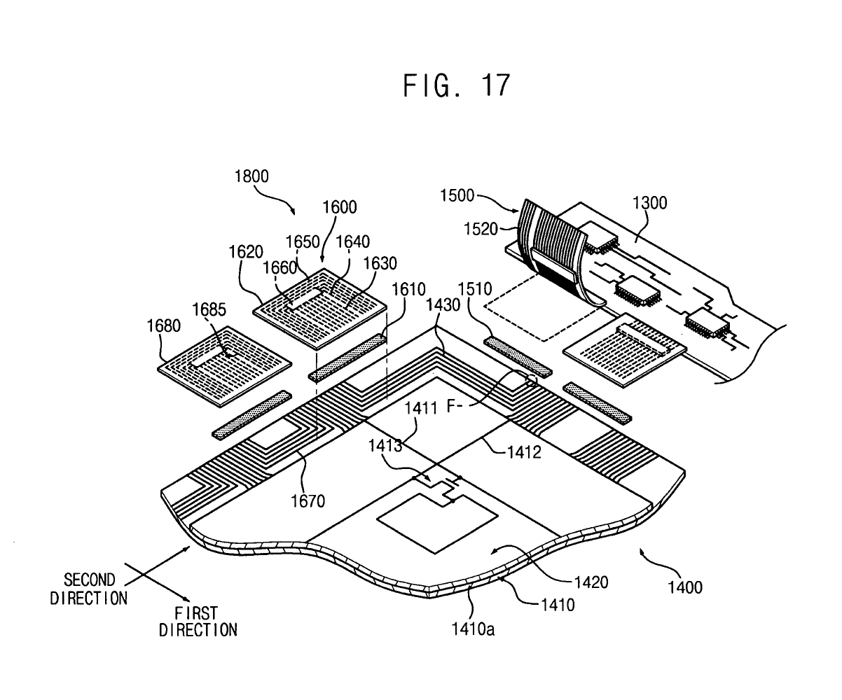

FIG. 16 is a perspective view illustrating another exemplary embodiment of a resin-extruding path.

Referring to FIGS. 14 and 16, a resin-extruding path 1232b has an inclined direction relative to the second peripheral portion 1211b in a plan view.

Particularly, when the first input line 1232 is disposed in a direction perpendicular to the second peripheral portion 1211b, the resin-extruding path 1232b forms an angle between about zero to ninety degrees with respect to the second peripheral portion 1211b. Thus, the first input line 1232 with the resin-extruding path 1232b formed therein has a branch, leaf, or feather shape as illustrated, although other resin-extruding path shapes for promoting resin flow within the end portion of the first input line 1232 at the second peripheral portion 1211b is within the scope of these embodiments. The resin of the ACF is extruded along the resin extruding path 1232b formed on the first signal input line 1232.

FIG. 17 is an exploded perspective view illustrating an exemplary embodiment of a display apparatus.

Referring to FIG. 17, a display apparatus 1800 includes a unified printed circuit board (“PCB”) 1300, a display substrate 1400, a first signal transmission film 1500, a second signal transmission film 1600, and a resin-extruding path as will be further described below.

The unified PCB 1300 converts a display signal processed by an information-processing device such as a computer into a driving signal for displaying an image. The driving signal includes a gate signal (or timing signal) and a data signal.

The display substrate 1400 includes a thin film transistor (“TFT”) substrate 1410, a color filter substrate 1420, and a liquid crystal layer (not shown) interposed between the TFT substrate 1410 and the color filter substrate 1420.

The TFT substrate 1410 includes a transparent substrate 1410a such as a glass substrate and a pixel for displaying the image.

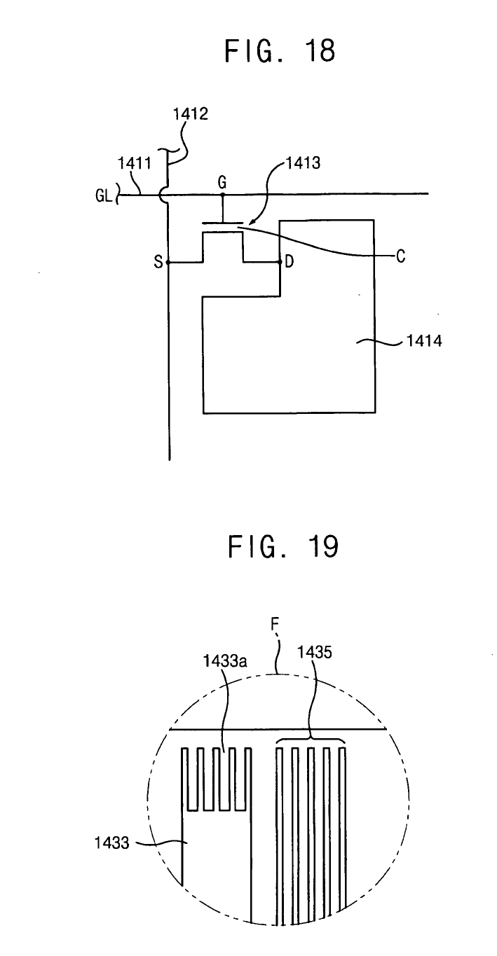

FIG. 18 is a circuit diagram illustrating a pixel formed on the TFT substrate 1410.

Referring to FIGS. 17 and 18, the pixel PE of the TFT substrate 1410 includes a gate line 1411 (also illustrated as GL), a data line 1412, a thin film transistor 1413, and a pixel electrode 1414.

The gate line 1411 is disposed on the transparent substrate 1410. The gate line 1411 is extended in a first direction, and at least two data lines 1412 are disposed in a second direction substantially perpendicular to the first direction. When the resolution of the display substrate 1400 is 1024×768, 768 units of the gate lines 1411 are formed on the display substrate 1400. The gate lines 1411 are spaced apart from each other by a uniform interval.

The gate lines 1411 are grouped into four groups. Each of the four groups has 256 units of the gate lines 1411. Hereinafter, each group defines a gate channel. Therefore, the display substrate 1400 having a resolution of about 1024×768 includes four gate channels, and a gate tape carrier package (“TCP”) illustrated as second signal transmission film 1600 is combined with each of the gate channels.

The data line 1412 is disposed in the second direction on the transparent substrate 1410a. An insulation layer (not shown) is interposed between the gate lines 1411 and the data line 1412, so that the data line 1412 and the gate lines 1411 are electrically insulated from each other so as to prevent undesired shorting therebetween.

When the display substrate 1400 has the resolution of about 1024×768, 1024×3 units of data lines 1412 are formed on the display substrate, and each of the data lines 1412 is disposed in parallel with one another.

The data lines 1412 are grouped into twelve groups. Each of the twelve groups has 256 units of data lines 1412. Hereinafter, each of the groups is defined as a data channel. Therefore, the display substrate 1400 having a resolution of about 1024×768 includes about twelve gate channels, and a data tape carrier package 1500, illustrated as first signal transmission film, is combined with each of the data channels.

The thin film transistor 1413 is disposed at a portion where each of the gate lines 1411 crosses each of the data lines 1412. The thin film transistor 1413 includes a gate electrode G, a channel layer C, a source electrode S, and a drain electrode D. The gate electrode G is electrically connected to the gate line 1411. The channel layer C is insulated from the gate electrode G by an insulating layer. The source electrode S has a first end portion and a second end portion corresponding to the first end portion. The first end portion of the source electrode S is electrically connected to the data line.1412 and the second end portion of the source electrode S is electrically connected to the channel layer C. The drain electrode D is electrically connected to the channel layer C. The source and drain electrodes S and D formed on the channel layer C are spaced apart from each other by a predetermined interval. When a voltage is applied to the gate electrode G, the channel layer C operates as a conductor, and when the voltage is not applied to the gate electrode G, the channel layer C operates as an insulator.

The pixel electrode 1414 is electrically connected to each of the drain electrodes D. The pixel electrode 1414 is disposed in a region that is formed by the adjacent gate lines 1411 and the adjacent data lines 1412. The pixel electrode includes a transparent conductive film such as, but not limited to, indium tin oxide (“ITO”), indium zinc oxide (“IZO”), amorphous indium tin oxide (“a-ITO”), etc.

The gate signal generated from the unified PCB 1300 is applied to the gate line 1411 of the gate channel in a sequence by an order. The data signal generated from the unified PCB 1300 is applied to the data line 1412 of the data channel in a sequence by an order.

The data tape carrier package shown as the first signal transmission film 1500 is electrically connected to the data channel within the display substrate 1400 through the ACF 1510 to apply a data signal that is generated from the unified PCB 1300 to each of the data channels. The ACF 1510 includes a resin having an insulating material and micro-conductive balls. The micro-conductive balls make contact with each other through pressure or heat, so that the unified PCB 1300 transmits the data signal to the data line 1412 of the data channel.

A gate signal-transferring pattern 1520 is formed on one of the data tape carrier packages 1500 so as to apply the gate signal that is generated from the unified PCB 1300 to a first transferring pattern 1430.

The gate signal that is generated from the unified PCB 1300 is applied to the gate line 1411 of the gate channel through the first transferring pattern 1430 and the gate tape carrier package shown as the second signal transmission film 1600.

The first transferring pattern 1430 is disposed on a corner portion of the transparent substrate 1410a of the thin film transistor substrate 1410. The first transferring pattern 1430 transfers the gate signal generated from the unified PCB 1300 to the gate tape carrier package 1600 through the thin film transistor substrate 1410. A number of lines within the first transferring pattern 1430 is substantially equal to a number of gate channels.

The gate tape carrier package 1600 includes a base body 1620, a first conductive pattern 1630, a second conductive pattern 1640, a third conductive pattern 1650, and a driver IC 1660.

The driver IC 1660 is disposed on the base body 1620, and the first conductive pattern 1630 is electrically connected to a signal output bump, i.e. terminal, (not shown) of the driver IC 1660.

A number of lines within the first conductive pattern 1630 is substantially equal to a number of the gate lines 1114 within its associated gate channel. More particularly, the first conductive pattern 1630 corresponds to the gate lines 1411 belonging to the gate channel and the first conductive pattern 1630 is electrically connected to the gate lines 1411.

The second conductive pattern 1640 has a first end portion and a second end portion opposite the first end portion. The first end portion of the second conductive pattern 1640 is electrically connected to a signal input bump, i.e. terminal, (not shown) of the driver IC 1660. The second end portion of the second conductive pattern 1640 corresponds to the first transferring pattern 1430. Thus, the gate signal outputted from the gate signal transferring pattern 1520 formed on the data tape carrier package 1500 and the first transferring pattern 1430 is applied to the driver IC 1660 through the second conductive pattern 1640.

The gate signal that generates from the unified PCB 1300 is applied to the third conductive pattern 1650. The third conductive pattern 1650 bypasses the driver IC 1660 on the base body 1620. The third conductive pattern 1650 is electrically coupled to the first transferring pattern 1430.

A second transferring pattern 1670 applies the gate signal outputted from the third conductive pattern 1650 to the second conductive pattern 1685 of an adjacent gate tape carrier package 1600 illustrated as having a base body 1680. Additional transferring patterns formed on the TFT substrate 1410 may be provided for applying gate signals outputted from prior gate tape carrier packages 1600 to latter tape carrier packages 1600.

The first conductive pattern 1630 of the gate tape carrier package 1600 is electrically coupled to each of the gate lines 1411 of the gate channel.

Therefore, when a width and a thickness of the first transferring pattern 1430 are decreased, the electric resistivity of the first transferring pattern 1430 is increased, where electric resistivity indicates how strongly the flow of electric current is opposed. Thus, the gate signal generated from the unified PCB 1300 may be distorted when the gate signal is applied to the first transferring pattern 1430 if a portion of the first transferring pattern 1430 is decreased in width and thickness.

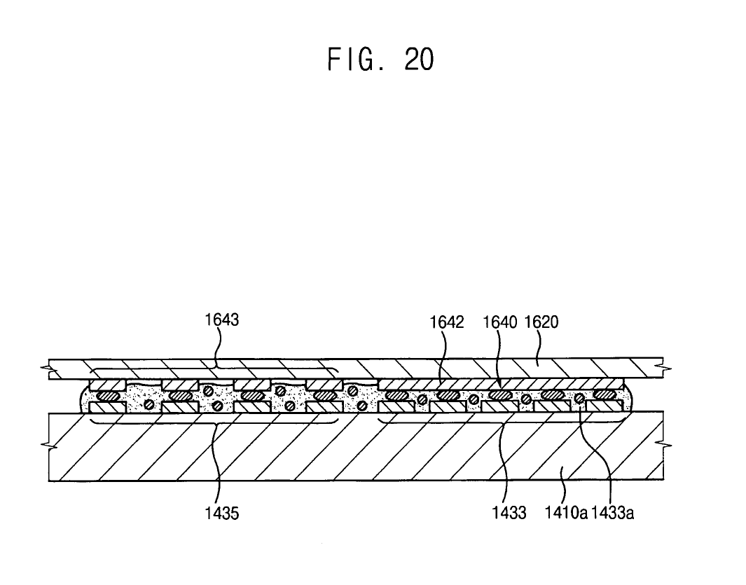

FIG. 19 is an enlarged view illustrating a portion of ‘F’ in FIG. 17. FIG. 20 is a cross sectional view illustrating an exemplary embodiment of the thin film transistor substrate combined with the gate tape carrier package.

Referring to FIGS. 19 and 20, the first transferring pattern 1430 includes a power signal providing pattern 1433 and a timing signal providing pattern 1435. The power signal providing pattern 1433, having a first width, outputs a power signal having a first voltage level. The timing signal providing pattern 1435 includes a plurality of lines, each line having a second width that is less than the first width, and the timing signal providing pattern 1435 outputs a timing signal having a second voltage level that is lower than the first voltage level.

With the first width of the power signal providing pattern 1433 increased, the electric resistivity of the power providing pattern 1433 is decreased. However, when the first width of the power signal providing pattern 1433 is increased, an extruding of resin of the ACF between the gate tape carrier package 1600 and the power signal providing pattern 1433 is reduced.

In order to increase extrusion of resin between the gate TCP 1600 and the power signal providing pattern 1433, a resin-extruding path 1433a is formed on the power signal providing pattern 1433 of the first transferring pattern 1430 at a first end portion adjacent the data TCP 1500 and at a second end portion adjacent the gate TCP 1600. When the ACF 1610 between the power signal providing pattern 1433 and the gate tape carrier package 1600 is pressed, the resin of the ACF 1610 is easily extruded through the resin-extruding path 1433a, so that micro-conductive balls of the ACF 1610 make contact with the second conductive pattern 1640 of the gate tape carrier package 1600 and the power signal providing pattern 1433.

The resin-extruding path 1433a for extruding the resin of the ACF may have various shapes, such as, for example, a fork shape as illustrated, or a branch shape, etc.

In the cross-sectional view shown in FIG. 20, the second conductive pattern 1640 of the gate tape carrier package 1600 includes a first sub pattern 1642 and a second sub pattern 1643. The first sub pattern 1642 is electrically connected to the power signal providing pattern 1433 of the first transferring pattern 1430. The second sub pattern 1643 is electrically connected to the timing signal providing pattern 1435.

In this exemplary embodiment, the resin-extruding path 1433a is formed on the power signal providing pattern 1433 that makes electrical contact with the first sub pattern 1642.

When the ACF 1610 between the power signal providing pattern 1433 and the first sub pattern 1642 is pressed, the resin of the ACF 1610 is easily extruded through the resin-extruding path 1433a, so that micro-conductive balls of the ACF 1610 make contact with the power signal providing pattern 1433 of the first transferring pattern 1430.

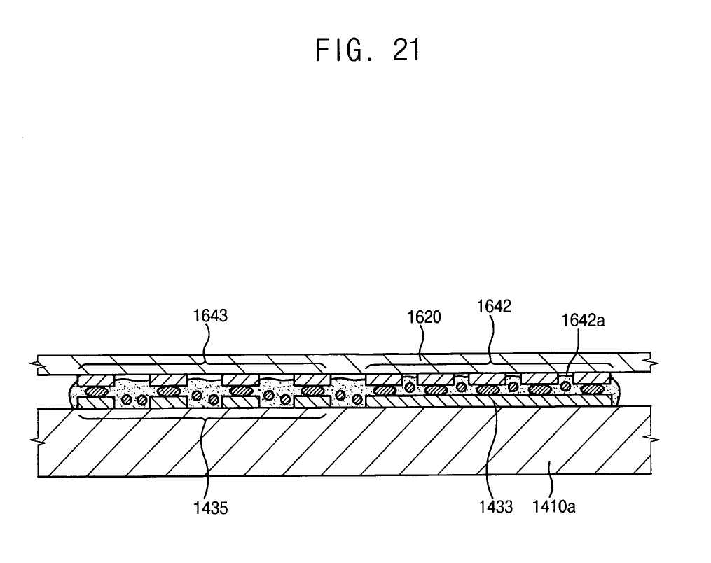

FIG. 21 is a cross sectional view illustrating another exemplary embodiment of a thin film transistor combined with a gate tape carrier package.

Referring to FIG. 21, and similar to FIG. 20, the second conductive pattern 1640 of the gate tape carrier package 1600 includes a first sub pattern 1642 and a second sub pattern 1643. The first sub pattern 1642 is electrically connected to the power signal providing pattern 1433 of the first transferring pattern 1430. The second sub pattern 1643 is electrically connected to the timing signal providing pattern 1435.

In this exemplary embodiment, the resin-extruding path 1642a is formed on the first sub pattern 1642 that makes electrical contact with the power signal providing pattern 1433. The resin-extruding path 1642a of the first sub pattern 1642 may be formed with a fork shape as previously described, or may have alternate shapes.

When the ACF 1610 between the power signal providing pattern 1433 and the first sub pattern 1642 is pressed, the resin of the ACF 1610 is easily extruded through the resin-extruding path 1642a, so that micro-conductive balls of the ACF 1610 make contact with the second conductive pattern 1640 and the first sub pattern 1642.

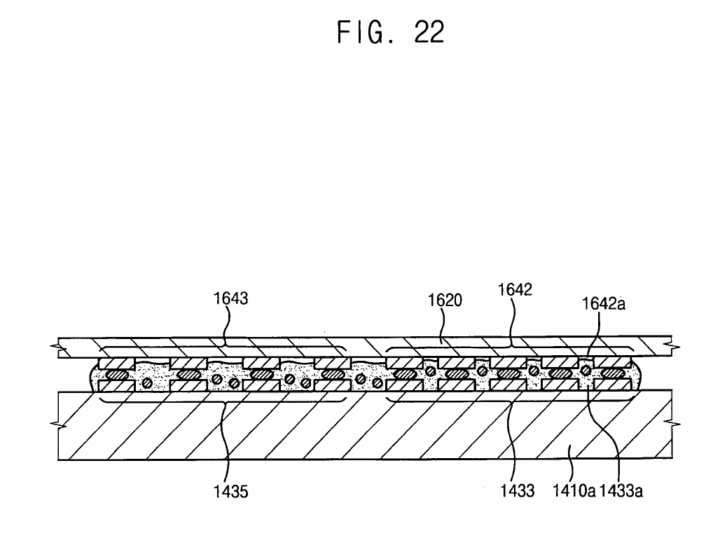

FIG. 22 is a cross sectional view illustrating still another exemplary embodiment of a thin film transistor substrate combined with a gate tape carrier package.

Referring to FIG. 22, the second conductive pattern 1640 of the gate tape carrier package 1600 includes a first sub pattern 1642 and a second sub pattern 1643. The first sub pattern 1642 is electrically connected to the power signal providing pattern 1433 of the first transferring pattern 1430. The second sub pattern 1643 is electrically connected to the timing signal providing pattern 1435.

In the exemplary embodiment illustrated in FIG. 22, a first resin-extruding path 1642a is formed on the first sub pattern 1642 that makes electrical contact with the power signal providing pattern 1433, and a second resin-extruding path 1433a is disposed between the prongs of the end portion of the power signal providing pattern 1433.

The first resin-extruding path 1642a corresponds to the second resin-extruding path 1433a.

When the ACF 1610 between the second resin extruding portion 1433a and the first resin-extruding path 1642a is pressed, the resin of the ACF 1610 is easily extruded through the first and second resin-extruding paths 1642a and 1433a, so that micro-conductive balls of the ACF 1610 make contact with the first sub pattern 1642 and the power signal providing pattern 1433.

The resin-extruding paths described herein may take on varying patterns, and may generally include slots formed in end portions of the pattern lines.

Thus, embodiments have been described for enhancing stability between a display panel and a gate FPC, such as a tape carrier package, via the ACF. The stability may be enhanced by providing the above-described resin-extruding path within a sub-pattern having a larger width than other lines within a pattern. Stability may further be enhanced by providing varying widths of the end portions of lines within the pattern. It should be understood that any combination of the above-described embodiments would also be within the scope of this invention. While stability is enhanced via the slots of the resin-extruding path and the differing widths of end portions of the pattern lines, contact resistance is additionally reduced.

Having described the exemplary embodiments of the present invention and its advantages, it is noted that various changes, substitutions and alterations can be made herein without departing from the spirit and scope of the invention as defined by appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A liquid crystal display device comprising:
a liquid crystal display panel including a plurality of gate lines extended along a first direction, a plurality of gate pads that are electrically connected to the gate lines, respectively, a gate driving control signal line that transfers a gate driving control signal, and a gate driving control signal pad that is electrically connected to the gate driving control signal line;
a flexible circuit film including a gate driving chip that applies a gate driving signal to the gate lines based on the gate driving control signal, a plurality of gate signal terminals that are electrically connected to the gate pads, respectively, and a gate driving terminal having at least two sub terminals electrically connected to each other, each of the sub terminals being electrically connected to the gate driving control signal pad; and
an anisotropic conductive film disposed between the liquid crystal display panel and the flexible circuit film to electrically connect the flexible circuit film to the liquid crystal display panel.

2. The liquid crystal display device of claim 1, wherein a width of the gate driving terminal is wider than a width of each gate signal terminal.

3. The liquid crystal display device of claim 2, wherein each of the sub terminals has a substantially same width as the width of each gate signal terminal, and the sub terminals are arranged along a width-wise direction in the flexible circuit film.

4. The liquid crystal display device of claim 3, wherein the gate driving control signal comprises a gate on signal for turning on a switching device that is electrically connected to the gate line.

5. The liquid crystal display device of claim 4, wherein the gate driving control signal pad comprises a first pad, and the gate driving terminal comprises a first terminal corresponding to the first pad.

6. The liquid crystal display device of claim 3, wherein the gate driving control signal comprises a gate off signal for turning off a switching device that is electrically connected to the gate line.

7. The liquid crystal display device of claim 6, wherein the gate driving control signal pad comprises a first pad and a second pad, and the gate driving terminal comprises a first terminal and a second terminal, the first terminal corresponding to the first pad, and the second terminal corresponding to the second pad.

8. The liquid crystal display device of claim 1, wherein the anisotropic conductive film comprises:
a resin that connects the flexible circuit film to the liquid crystal display panel; and
a plurality of conducting balls distributed within the resin.

9. The liquid crystal display device of claim 1, wherein the sub terminals comprise:
a first sub terminal having a first terminal width that is substantially equivalent to a width of each gate signal terminal; and
a second sub terminal having a second terminal width wider than the first terminal width.

10. The liquid crystal display device of claim 9, further comprising a plurality of first sub terminals and a plurality of second sub terminals, wherein the first and second sub terminals are alternatingly arranged within the gate driving terminal.

11. The liquid crystal display device of claim 10, wherein the second terminal width is approximately three times wider than the first terminal width.

12. The liquid crystal display device of claim 10, wherein the gate driving control signal comprises a gate on signal for turning on a switching device that is electrically connected to the gate line.

13. The liquid crystal display device of claim 12, wherein the gate driving control signal pad comprises a first pad, and the gate driving terminal comprises a first terminal corresponding to the first pad.

14. The liquid crystal display device of claim 10, wherein the gate driving control signal comprises a gate off signal for turning off a switching device that is electrically connected to the gate line.

15. The liquid crystal display device of claim 14, wherein the gate driving control signal pad comprises a first pad and a second pad, and the gate driving terminal comprises a first terminal and a second terminal, the first terminal corresponding to the first pad and the second terminal corresponding to the second pad.

16. The liquid crystal display device of claim 1, wherein the gate driving terminal includes a first terminal and a second terminal, the first terminal including a first connecting portion having a plurality of sub terminals extending therefrom, the second terminal including a second connecting portion having a plurality of sub terminals extending therefrom, the second terminal having a greater number of sub terminals than the first terminal.

17. The liquid crystal display device of claim 16, wherein each sub terminal within the plurality of sub terminals has a width that is equivalent to a width of each gate signal terminal.

18. The liquid crystal display device of claim 16, wherein each sub terminal within a first set of sub terminals within the plurality of sub terminals within the second terminal has a first width, and each sub terminal within a second set of sub terminals within the plurality of sub terminals within the second terminal has a second width, and the second width is greater than the first width.

19. The liquid crystal display device of claim 18, wherein the first terminal includes a first sub terminal having the first width and a second sub terminal having the second width.

20. A liquid crystal display device comprising:
a liquid crystal display panel including a plurality of gate lines extended along a first direction, a plurality of gate pads that are electrically connected to the gate lines, respectively, a gate driving control signal line that transfers a gate driving control signal, and a gate driving control signal pad that is electrically connected to the gate driving control signal line;
a flexible circuit film including a gate driving chip that applies a gate driving signal to the gate lines based on the gate driving control signal, a plurality of gate signal terminals that are electrically connected to the gate pads, respectively, and a gate driving terminal having at least two sub terminals electrically connected to each other, each of the sub terminals being electrically connected to the gate driving control signal pad;
an anisotropic conductive film disposed between the liquid crystal display panel and the flexible circuit film to electrically connect the flexible circuit film to the liquid crystal display panel; and
a backlight assembly disposed adjacent the liquid crystal display panel to provide the liquid crystal display panel with light.

21. The liquid crystal display device of claim 20, wherein a width of the gate driving terminal is wider than a width of each gate signal terminal.

22. The liquid crystal display device of claim 21, wherein each of the sub terminals has a substantially same width as the width of each gate signal terminal, and the sub terminals are arranged along a width-wise direction in the flexible circuit film.

23. The liquid crystal display device of claim 21, wherein the sub terminals comprise:
a first sub terminal having a first terminal width substantially equivalent to the width of each gate signal terminal; and
a second sub terminal having a second terminal width wider than the first terminal width, the gate driving terminal including a plurality of first sub terminals and a plurality of second sub terminals that are alternatingly arranged within the gate driving terminal.

24. The liquid crystal display device of claim 21, wherein the gate driving control signal comprises a gate on signal for turning on a switching device that is electrically connected to the gate line.

25. The LCD device of claim 24, wherein the gate driving control signal pad comprises a first pad, and the gate driving terminal comprises a first terminal corresponding to the first pad.

26. The liquid crystal display device of claim 25, wherein the gate driving control signal further comprises a gate off signal for turning off a switching device that is electrically connected to the gate line.

27. The liquid crystal display device of claim 26, wherein the gate driving control signal pad further comprises a second pad, and the gate driving terminal further comprises a second terminal corresponding to the second pad.

28. The LCD device of claim 20, wherein the backlight assembly comprises:
a lamp that generates the light;
an optical member that alters a path of the light; and
a receiving container that receives the lamp and the optical member.

29. A flexible circuit film for use on a thin film transistor substrate of a liquid crystal display panel, the flexible circuit film comprising:
a gate signal terminal; and,
a gate driving terminal, the gate driving terminal having a first terminal, the first terminal having a plurality of sub terminals electrically connected to each other and spaced apart from each other within the first terminal, the first terminal having a first terminal width that is larger than a width of the gate signal terminal.

30. The flexible circuit film of claim 29, wherein each sub terminal in the plurality of sub terminals has a width that is equivalent to the width of the gate signal terminal.

31. The flexible circuit film of claim 29, further comprising a second terminal within the gate driving terminal, the second terminal having a plurality of sub terminals electrically connected to each other, the second terminal having a second terminal width that is larger than the first terminal width.

32. The flexible circuit film of claim 29, further comprising a second terminal within the gate driving terminal, the second terminal having a plurality of sub terminals electrically connected to each other, the second terminal having a greater quantity of sub terminals than the first terminal.

33. The flexible circuit film of claim 32, wherein each sub terminal in the first terminal and the second terminal has a width that is equivalent to the width of the gate signal terminal.

34. The flexible circuit film of claim 32, wherein each sub terminal within a first set of sub terminals within the plurality of sub terminals within the second terminal has a first sub terminal width, and each sub terminal within a second set of sub terminals within the plurality of sub terminals within the second terminal has a second sub terminal width, and the second sub terminal width is greater than the first sub terminal width.

35. The flexible circuit film of claim 34, wherein the first terminal includes a first sub terminal having the first sub terminal width and a second sub terminal having the second sub terminal width.

36. The flexible circuit film of claim 34, wherein the second terminal has a second terminal width, the second terminal further including a connecting portion extending the second terminal width, the plurality of sub terminals within the second terminal extending from the connecting portion, and sub terminals having the first sub terminal width alternating with sub terminals having the second sub terminal width along the connecting portion.

37. A signal transmission film comprising:
a body; and
a conductive pattern formed on the body, a portion of the conductive pattern having a resin-extruding path, the portion making contact with an anisotropic conductive film including a resin and a micro-conductive ball and, when the signal transmission film is combined with the anisotropic conductive film, the resin is extruded through the resin-extruding path.

38. The signal transmission film of claim 37, wherein the resin-extruding path is formed along a longitudinal direction of the conductive pattern.

39. The signal transmission film of claim 37, wherein the resin-extruding path is formed from an inner portion of the conductive pattern toward a side of the conductive pattern such that a longitudinal direction of the resin-extruding path forms an acute angle with respect to the side of the conductive pattern.

40. The signal transmission film of claim 37, wherein the conductive pattern is at least two-pronged to form the resin-extruding path.

41. A signal transmission film comprising:
a base substrate including a first peripheral portion and a second peripheral portion opposite the first peripheral portion;
a driver integrated circuit disposed on the base substrate, the driver integrated circuit including a plurality of first terminals and a plurality of second terminals;
a plurality of first conductive patterns extended in parallel with each other from the first peripheral portion to the first terminals and electrically connected to the first terminals, respectively; and
a plurality of second conductive patterns extended in parallel with each other from the first peripheral portion to the second terminals and electrically connected to the second terminals, respectively, the second conductive patterns having a first resin-extruding path formed at the first peripheral portion.

42. The signal transmission film of claim 41, wherein the first resin-extruding path has a fork shape to extrude resin.

43. The signal transmission film of claim 41, further comprising a plurality of third conductive patterns extended in parallel with each other from a first end portion of the first peripheral portion to a second end portion of the first peripheral portion and through a region disposed between the driver integrated circuit and the second peripheral portion, the third conductive patterns having a second resin-extruding path formed at the first peripheral portion.

44. The signal transmission film of the claim 43, wherein the second resin-extruding path has a fork shape to extrude resin.

45. The signal transmission film of claim 41, wherein the second conductive patterns comprise a first sub pattern that receives a first driving signal having a first voltage level and a second sub pattern that receives a second driving signal having a second voltage level that is lower than the first voltage level.

46. The signal transmission film of claim 45, wherein the first resin-extruding path is formed at the first sub pattern.

47. The signal transmission film of claim 43, wherein the third conductive patterns comprise a third sub pattern that receives a third driving signal having a third voltage level and a fourth sub pattern that receives a fourth driving signal having a fourth voltage level that is lower than the third voltage level.

48. The signal transmission film of claim 47, wherein the second resin-extruding path is formed at the third sub pattern.

49. A signal transmission film comprising:
a base substrate including a first peripheral portion and a second peripheral portion opposite the first peripheral portion;
a driver integrated circuit formed on the base substrate, the driver integrated circuit including a plurality of first terminals and a plurality of second terminals;
a plurality of first conductive patterns extended in parallel with each other from the first peripheral portion to the first terminals and electrically connected to the first terminals, respectively; and
a plurality of second conductive patterns extended in parallel with each other from the second peripheral portion to the second terminals and electrically connected to the second terminals, respectively, the second conductive patterns having a resin-extruding path formed at the second peripheral portion.

50. The signal transmission film of claim 49, wherein the resin-extruding path has a fork shape.

51. The signal transmission film of claim 50, wherein the resin-extruding path is formed along a direction substantially perpendicular to the second peripheral portion.

52. The signal transmission film of claim 49, wherein the resin-extruding path has a branch shape.

53. The signal transmission film of claim 49, wherein the resin-extruding path is formed in a direction that is inclined with respect to the second peripheral portion.

54. The signal transmission film of claim 49, wherein the second conductive patterns comprise a first sub conductive pattern having a first width and a second sub conductive pattern having a second width larger than the first width.

55. The signal transmission film of the claim 54, wherein the resin-extruding path is formed at the second sub conductive pattern.

56. A display apparatus comprising:
a unified printed circuit board generating a first driving signal and a second driving signal;
a display panel including a first signal line having a first width and a second signal line having a second width larger than the first width;
a signal transmission film including:
a base film;
a first driving signal line transferring the first driving signal to the first signal line; and
a second driving signal line transferring the second driving signal to the second signal line, the second driving signal line including a resin-extruding path; and
an anisotropic conductive film interposed between the signal transmission film and the display panel, the anisotropic conductive film including a reflowable resin and a micro-conductive ball, the resin being extruded through the resin-extruding path when the anisotropic conductive film is combined with the signal transmission film.

57. The display apparatus of the claim 56, wherein the resin-extruding path has a fork shape.

58. The display apparatus of the claim 56, wherein the resin-extruding path has a branch shape.

59. A display apparatus comprising:
a display panel having a signal providing pattern;
a signal transmission film including a conductive pattern;
a resin extruding path formed in at least one of the signal providing pattern and the conductive pattern; and,
an anisotropic conductive film interposed between an end portion of the signal providing pattern and an end portion of the conductive pattern, the anisotropic conductive film including a resin extruded through the resin-extruding path.

60. The display apparatus of claim 59 further comprising slots within an end portion of the signal providing pattern, the slots forming the resin-extruding path.

61. The display apparatus of claim 60 further comprising a first sub pattern and a second sub pattern within the signal providing pattern, the first sub pattern having a first width and the resin-extruding path, the second sub pattern having a plurality of lines, each line having a second width, the first width being larger than the second width.

62. The display apparatus of claim 59 further comprising slots within an end portion of the conductive pattern, the slots forming the resin-extruding path.

63. The display apparatus of claim 62 further comprising a first sub pattern and a second sub pattern within the conductive pattern, the first sub pattern having a first width and the resin-extruding path, the second sub pattern having a plurality of lines, each line having a second width, the first width being larger than the second width.
